(19) United States
(12) Patent Application Publication
(10) Pub. No.: US 2026/0245851 A1
(43) Pub. Date: Aug. 20, 2026

(54) PAPER-BASED MICROFLUIDIC PLATFORM AND METHOD FOR PARTICLE SPECTROMETRY ANALYSIS

(71) Applicant: THE TRUSTEES OF INDIANA UNIVERSITY, Bloomington, IN (US)

(72) Inventors: Nicholas E. MANICKE, Zionsville, IN (US); Magnus P. RYDBERG, Carmel, IN (US)

(21) Appl. No.: 19/164,331

(22) PCT Filed: Mar. 20, 2024
(86) PCT No.: PCT/US2024/020614

§ 371 Date: Sep. 11, 2025

Related U.S. Application Data
(60) Provisional application No. 63/454,688, filed on Mar. 26, 2023.

(51) Int. Cl. H01J 49/04; H01J 49/16

(52) U.S. Cl. CPC H01J 49/0445; H01J 49/165

(57) ABSTRACT

An analyte stacking device for concentrating an analyte for particle spectrometry may include a substrate having first and second ends with a spray tip at the second end, a sample solution including the analyte, a background electrolyte (BGE) solution, a voltage source to establish an electric field across the substrate, wherein, in response to the electric field, the BGE solution flows into and through the substrate, the analyte flows through the substrate toward the BGE solution and, upon meeting of the analyte with the BGE solution, an interface is formed along which the analyte becomes concentrated to form a sample band of the analyte, and means for controlling a flow rate of the BGE solution to the substrate so as to control a magnitude of flow velocity of the BGE in the substrate in a manner which moves the sample band of the analyte toward the spray tip.

### CROSS-REFERENCE TO RELATED APPLICATION

This international patent application claims the benefit of, and priority to, U.S. Provisional Patent Application Ser. No. 63/454,688, filed Mar. 26, 2023, the disclosure of which is expressly incorporated herein by reference in its entirety.

### GOVERNMENT RIGHTS

This invention was made with government support under GM149786 awarded by the National Institutes of Health. The government has certain rights in the invention.

### TECHNICAL FIELD

The present disclosure relates generally to systems and methods for particle spectrometry analysis of samples.

### BACKGROUND

Mass spectrometry (MS) is a highly effective tool for the analysis of complex mixtures. Mass spectrometry analyses are often coupled with offline extraction (such as solid phase extraction or liquid-liquid extraction) and with online separations (e.g., high performance liquid chromatography (HPLC) and capillary electrophoresis (CE)). Such approaches provide high sensitivity, reliable quantitation, and molecular specificity. It may be desirable to seek improvements to these and/or other particle spectrometry approaches, such as, but not limited to, simplifying the approaches, decreasing the amount of labor included in the approaches, and/or simplifying the systems used in the approaches.

### SUMMARY

The present disclosure may comprise one or more of the features recited in the attached claims, and/or one or more of the following features and combinations thereof. In a first aspect, an analyte stacking device for concentrating an analyte of interest for particle spectrometry may comprise a porous substrate having a first end and a second end opposite the first end, the second end defining a spray tip; a sample solution comprising the analyte of interest; a background electrolyte (BGE) solution fluidly coupled to one of the first or second end of the porous substrate; a first voltage source configured to apply a first voltage across the porous substrate to establish a first electric field between the first and second ends of the porous substrate; wherein, with the sample solution applied to the porous substrate and in response to the first electric field across the porous substrate, the BGE solution flows through the porous substrate with a first flow velocity in a first direction from the one of the first or second end of the porous substrate toward the other of the first or second end of the porous substrate, the analyte of interest flows through the porous substrate toward the BGE solution with a second flow velocity in a second direction opposite the first direction and, upon meeting of the analyte of interest with the BGE solution, an interface is formed on the porous substrate along which the analyte of interest becomes concentrated to form a sample band of the analyte of interest; and means for controlling a flow rate of the BGE solution to the one of the first or second end of the porous substrate so as to control a magnitude of the first flow velocity relative to a magnitude of the second flow velocity in a manner which moves the sample band of the analyte of interest toward the spray tip.

A second aspect includes the features of the first aspect, and wherein the spray tip may form a Taylor cone.

A third aspect includes the features of the first aspect, and the stacking device may further comprise a capillary extending from the spray tip, and wherein the analyte of interest may pass from the spray tip through the capillary.

A fourth aspect includes the features of any of the first through the fifth aspects, and the stacking device may further comprise a reservoir configured to receive the BGE solution such that the BGE solution flows from the reservoir to the one of the first or second end of the porous substrate.

A fifth aspect includes the features of the fourth aspect, and wherein the means for controlling the flow rate of the BGE solution to the one of the first or second end of the porous substrate may comprise a temperature control unit configured to cool the reservoir and the BGE solution received therein.

A sixth aspect includes the features of any of the first through the fifth aspects, and the stacking device may further comprise a voltage source connection substrate coupled to one of the first or second end of the porous substrate opposite the BGE solution.

A seventh aspect includes the features of the sixth aspect, and wherein the voltage source connection substrate may be coupled to the second end of the porous substrate and may include a first end and a second end opposite the first end, the second end may define a sharp tip, and wherein the sharp tip of the voltage source connection substrate may contact the spray tip of the porous substrate.

An eighth aspect includes the features of the seventh aspect, and wherein an angle of about 30 degrees may be formed between the porous substrate and the voltage source connection substrate.

A ninth aspect includes the features of any of the first through the eighth aspects, and wherein the means for controlling the flow rate of the BGE solution to the one of the first or second end of the porous substrate may comprise a flow substrate configured to direct the BGE solution to the one of the first or second end of the porous substrate.

A tenth aspect includes the features of the ninth aspect, and wherein the flow substrate may be a low flow rate filter paper.

An eleventh aspect includes the features of the ninth aspect, and wherein a width of the flow substrate may be adjusted to control the flow rate of the BGE

### Solution

A twelfth aspect includes the features of any of the first through the eleventh aspects, and wherein the means for controlling the flow rate of the BGE solution to the one of the first or second end of the porous substrate may comprise a pump configured to direct the BGE solution to the one of the first or second end of the porous substrate.

In a thirteenth aspect, a charged particle separation system may comprise a charged particle separation instrument having a charged particle inlet, the charged particle separation instrument configured to separate charged particles as a function of at least one molecular characteristic; an ion source including the features of the analyte stacking device of any of the first through twelfth aspects, wherein the spray tip is spaced apart from the charged particle inlet of the charged particle separation instrument to define a gap, and wherein the first voltage source is configured to establish a first voltage at the second end of the porous substrate; and a second voltage source configured to establish a second voltage at the charged particle inlet of the charged particle separation instrument so as to establish a second electric field between the spray tip of the analyte stacking device and the charged particle inlet of the charged particle separation instrument, the second electric field causing the spray tip to spray charged particles of the analyte of interest toward and into the inlet of the charged particle separation instrument.

In a fourteenth aspect, an analyte stacking device for concentrating an analyte of interest for particle spectrometry may comprise a porous substrate having a first end and a second end opposite the first end, the second end defining a spray tip; a sample solution comprising the analyte of interest; a background electrolyte (BGE) solution fluidly coupled to one of the first or second end of the porous substrate; a first voltage source configured to apply a first voltage across the porous substrate to establish a first electric field between the first and second ends of the porous substrate; wherein, with the sample solution applied to the porous substrate and in response to the first electric field across the porous substrate, the BGE solution flows through the porous substrate with a first flow velocity in a first direction from the one of the first or second end of the porous substrate toward the other of the first or second end of the porous substrate, the analyte of interest flows through the porous substrate toward the BGE solution with a second flow velocity in a second direction opposite the first direction and, upon meeting of the analyte of interest with the BGE solution, an interface is formed on the porous substrate along which the analyte of interest becomes concentrated to form a sample band of the analyte of interest; and a flow substrate fluidly coupled with the first or second end of the porous substrate and configured to control a flow rate of the BGE solution to the one of the first or second end of the porous substrate so as to control a magnitude of the first flow velocity relative to a magnitude of the second flow velocity in a manner which moves the sample band of the analyte of interest toward the spray tip.

A fifteenth aspect includes the features of the fourteenth aspect, and wherein the spray tip may form a Taylor cone.

A sixteenth aspect includes the features of the fourteenth aspect, and the analyte stacking device may further comprise a capillary extending from the spray tip, and wherein the analyte of interest passes from the spray tip through the capillary.

A seventeenth aspect includes the features of any of the fourteenth through the sixteenth aspects, and the analyte stacking device may further comprise a reservoir configured to receive the BGE solution such that the BGE solution flows from the reservoir, to the flow substrate, and to the one of the first or second end of the porous substrate.

An eighteenth aspect includes the features of any of the fourteenth through the seventeenth aspects, and the analyte stacking device may further comprise a voltage source connection substrate coupled to one of the first or second end of the porous substrate opposite the flow substrate.

In a nineteenth aspect, a charged particle separation system may comprise a charged particle separation instrument having a charged particle inlet, the charged particle separation instrument configured to separate charged particles as a function of at least one molecular characteristic; an ion source including the features of the analyte stacking device of any of the fourteenth through eighteenth aspects, wherein the spray tip is spaced apart from the charged particle inlet of the charged particle separation instrument to define a gap, and wherein the first voltage source is configured to establish a first voltage at the second end of the porous substrate; and a second voltage source configured to establish a second voltage at the charged particle inlet of the charged particle separation instrument so as to establish a second electric field between the spray tip of the analyte stacking device and the charged particle inlet of the charged particle separation instrument, the second electric field causing the spray tip to spray charged particles of the analyte of interest toward and into the inlet of the charged particle separation instrument.

In a twentieth aspect, an analyte stacking device for concentrating an analyte of interest for particle spectrometry may comprise a porous substrate having a first end and a second end opposite the first end, the second end defining a spray tip; an angled substrate having a first end and a second end opposite the first end, the second end defining a sharp tip in contact with the spray tip so that the porous substrate and the angled substrate cooperate to form a fluid channel; a sample solution comprising the analyte of interest; a background electrolyte (BGE) solution fluidly coupled to the first end of the porous substrate; a first voltage source configured to apply a first voltage across the fluid channel to establish a first electric field between the first end of the porous substrate and the first end of the angled substrate; wherein, with the sample solution applied to the porous substrate and in response to the first electric field across the fluid channel, the BGE solution flows through the porous substrate with a first flow velocity in a first direction from the first end of the porous substrate toward the second end of the porous substrate, the analyte of interest flows through the porous substrate with the BGE solution in the first direction and onto the angled substrate and, in response to the first electric field and neutralization of the BGE solution, an ion-depletion zone is formed on the angled substrate, and upon meeting of the analyte of interest with the ion-depletion zone, the analyte of interest becomes concentrated to form a sample band of the analyte of interest, and the sample band of the analyte of interest is directed toward the sharp tip of the angled substrate and onto the spray tip of the porous substrate via a propagating ion-depletion zone.

A twenty-first aspect includes the features of the twentieth aspect, and wherein the spray tip may form a Taylor cone.

A twenty-second aspect includes the features of the twentieth aspect, and the analyte stacking device may further comprise a capillary extending from the spray tip, and wherein the analyte of interest passes from the spray tip through the capillary.

A twenty-third aspect includes the features of any of the twentieth through the twenty-second aspects, and the analyte stacking device may further comprise a reservoir configured to receive the BGE solution such that the BGE solution flows from the reservoir to the first end of the porous substrate.

A twenty-fourth aspect includes the features of the twenty-third aspect, and the analyte stacking device may further comprise a flow substrate configured fluidly coupled with the reservoir and the first end of the porous substrate to direct the BGE solution to the first end of the porous substrate.

A twenty-fifth aspect includes the features of any of the twentieth through the twenty-fourth aspects, and wherein an angle of about 30 degrees may be formed between the porous substrate and the angled substrate.

A twenty-sixth aspect includes the features of any of the twentieth through the twenty-fifth aspects, and wherein the analyte stacking device may include means for controlling a flow rate of the BGE solution to the second end of the porous substrate so as to control a magnitude of the first flow velocity in a manner which moves the sample band of the analyte of interest toward the spray tip.

A twenty-seventh aspect includes the features of any of the twentieth through the twenty-sixth aspects, and wherein the means for controlling the flow rate of the BGE solution to the second end of the porous substrate may comprise a temperature control unit configured to cool the reservoir and the BGE solution received therein.

A twenty-eighth aspect includes the features of any of the twentieth through the twenty-seventh aspects, and wherein the means for controlling the flow rate of the BGE solution to the second end of the porous substrate may comprise a flow substrate configured to direct the BGE solution onto the first end of the porous substrate.

A twenty-ninth aspect includes the features of the twenty-eighth aspect, and wherein the flow substrate may be a low flow rate filter paper.

A thirtieth aspect includes the features of the twenty-eighth aspect, and wherein a width of the flow substrate may be adjusted to control the flow rate of the BGE solution.

A thirty-first aspect includes the features of any of the twentieth through the thirtieth aspects, and wherein the means for controlling the flow rate of the BGE solution to the second end of the porous substrate may comprise a pump configured to direct the BGE solution onto the first end of the porous substrate.

In a thirty-second aspect, a charged particle separation system may comprise a charged particle separation instrument having a charged particle inlet, the charged particle separation instrument configured to separate charged particles as a function of at least one molecular characteristic; an ion source including the features of the analyte stacking device of any of the twentieth through thirty-first aspects, wherein the spray tip is spaced apart from the charged particle inlet of the charged particle separation instrument to define a gap, and wherein the first voltage source is configured to establish a first voltage at the second end of the porous substrate; and a second voltage source configured to establish a second voltage at the charged particle inlet of the charged particle separation instrument so as to establish a second electric field between the spray tip of the analyte stacking device and the charged particle inlet of the charged particle separation instrument, the second electric field causing the spray tip to spray charged particles of the analyte of interest toward and into the inlet of the charged particle separation instrument.

### BRIEF DESCRIPTION OF THE DRAWINGS

FIG. 1A is a depiction of an embodiment of a stacking device for stacking and elution of positively charged analytes;

FIG. 1B is a depiction of the transportation of a sample band toward a spray tip in an embodiment of a stacking device;

FIG. 1C is a depiction of the ionization of a sample in an embodiment of a stacking device;

FIG. 2A is a depiction of four substrates forming a continuous fluid channel;

FIG. 2B shows a porous substrate protruding in front of a voltage source connection substrate;

FIG. 2C shows the porous substrate of FIG. 2B protruding in front of the voltage source connection substrate;

FIG. 2D shows the four substrates of FIG. 2B in the stacking device;

FIG. 2E is a depiction of a cartridge attached to an aluminum stage;

FIG. 3 is a schematic of a circuit of one embodiment of a stacking device;

FIG. 4A is graph illustrating current verses time of one embodiment of a stacking device operated under 250 V in positive mode;

FIG. 4B is a depiction of field amplified sample stacking (FASS) of a cationic dye at 30 mM, on the left, and 80 mM, on the right, concentrations of a sample;

FIG. 4C is a graph illustrating the temperature of a substrate over time;

FIG. 4D is a graph illustrating the pH of a substrate over time during a stacking procedure;

FIG. 5A is a depiction of methylene blue molecules stacked via conductivity-FASS in a central region of a first substrate;

FIG. 5B is a depiction of methylene blue molecules moved in the direction of a spray tip by strong electroosmotic flow (EOF);

FIG. 5C is a depiction of methylene blue molecules moving and concentrating toward the spray tip by geometric-FASS;

FIG. 5D is a depiction of methylene blue molecules moving further into the spray trip by geometric-FASS;

FIG. 6 is a comparison of a graph illustrating the relative abundance over time of an analyte regularly and during a stacking procedure;

FIG. 7A is a depiction of a characteristic peak shape of a sample moving through a spray tip of an embodiment of a device;

FIG. 7B is a depiction of a characteristic peak shape of a sample band with high charge density moving into a spray tip of an embodiment of a device;

FIG. 7C is a depiction of a peak shape indicative of dispersion prior to elution of a sample in a spray tip of an embodiment of a device;

FIG. 8A is a graph of a signal of a 200 μl solution of fentanyl at 0.1 ng mL⁻¹ over time;

FIG. 8B is a graph of a signal of a 200 μl solution of Angiotensin II at 1.0 ng mL⁻¹ analyzed under different applied voltages;

FIG. 9 is a graph depicting calibration curves for fentanyl, cocaine, and morphine stacked from 80 μl of a sample solution;

FIG. 10A is a graph depicting calibration curves for perfluorooctanoic acid (PFOA) and perfluorooctanesulfonic acid (PFOS);

FIG. 10B is a graph depicting the MS/MS chronograms of various substrates with overlaid current verses time at an applied potential of 420 V;

FIG. 11A is a depiction of the relative abundance over time of methylene blue, rhodamine 6G, fentanyl, and methamphetamine stacked against a 35 mM background electrolyte (BGE);

FIG. 11B depicts the FASS separation of methylene blue and rhodamine 6G, showing that, because the mobility of methylene blue is higher than rhodamine 6G, methylene blue stacks farther down the electric field gradient, and further showing that reducing the steepness of the conductivity gradient promotes separation of molecules with different electrophoretic mobilities;

FIG. 11C depicts methylene blue and rhodamine 6G separated on a spray tip prior to elution;

FIG. 12A depicts the PS-MS spectra of rhodamine 6G sprayed from an unwashed modified glass fiber membrane;

FIG. 12B depicts the PS-MS spectra of rhodamine 6G stacked in an embodiment of a stacking device;

FIG. 13A depicts a schematic of electrophoretic elution for cationic analytes in a stacking device;

FIG. 13B depicts an analyte band traveling toward a spray tip in an embodiment of a stacking device;

FIG. 13C depicts the elution of an analyte in an embodiment of a stacking device;

FIG. 14 depicts the stacking and MS detection of methylene blue using on-cartridge FASS;

FIG. 15 shows a top perspective view of a base of an embodiment of a stacking device and two substrates being inserted into the base;

FIG. 16 is a perspective view of another substrate being inserted into the base of an embodiment of a stacking device;

FIG. 17 is a top down view of a porous substrate being inserted into a cartridge in an embodiment of a stacking device;

FIG. 18 is a front side view of a cartridge with a porous substrate therein being coupled to a base in an embodiment of a stacking device;

FIG. 19 is a top down view of a base having electric connectivity and a cartridge of an embodiment of a stacking device;

FIG. 20 is a perspective view of the cartridge and the base of FIG. 19;

FIG. 21 is a top down view of the stacking device of FIG. 19 with the cartridge coupled to the base;

FIG. 22 is a perspective view of an embodiment of a stacking device containing a porous substrate in a cartridge and facing an inlet of a MS device;

FIG. 23 is a perspective view of an embodiment of a stacking device including a cartridge containing a porous substrate and a base;

FIG. 24 is a depiction of three substrates forming a fluid channel;

FIG. 25 is a depiction of the stacking device of FIG. 23 in front of an inlet of a MS device;

FIG. 26 shows a porous substrate and a voltage source connection substrate of FIG. 24 contacting one another;

FIG. 27A depicts a net velocity of methylene blue through the porous substrate at three time points;

FIG. 27B depicts a concentration of methylene blue on the porous substrate at three time points;

FIG. 27C depicts a comparison between the BGE concentration gradient within the porous substrate under the condition of continuous titration verses the absence of neutralization reactions;

FIG. 28A is a graph showing extracted ion electropherograms of three high intensity intact peptides eluting simultaneously in a narrow sample band, and further showing that membrane impurities and methylene blue co-eluted with the peptides during regular stacking;

FIG. 28B is a graph showing electropherograms depicting analysis of the same peptide solutions as FIG. 28A with FASS separation;

FIG. 29A is a perspective view of a spray tip having a triangular shaped tip showing the E field strength at the spray tip;

FIG. 29B is a perspective view of a spray tip having a half pyramidal shaped tip showing the E field strength at the spray tip;

FIG. 29C is a perspective view of a spray tip of a porous substrate that converges with a voltage source connection substrate showing the E field strength at the spray tip;

FIG. 30A depicts a stacking device used to analyze high-conductivity samples using faradaic ion concentration polarization (f-ICP);

FIG. 30B is an enlarged view of a portion of FIG. 30A showing that cations from a sample deposited on a porous substrate migrated with the EOF to the boundary of an ion-depletion zone (IDZ) formed at an anode;

FIG. 31A depicts a sample on a voltage source connection substrate;

FIG. 31B depicts stacking of a sample band on the voltage source connection substrate;

FIG. 31C depicts the sample band moving toward a spray tip;

FIG. 31D depicts the sample band moving to the spray tip;

FIG. 32 is a graph showing extracted ion electropherograms for a fentanyl solution comparing FASS and f-ICP stacking;

FIG. 33A is a graph depicting a calibration curve for fentanyl;

FIG. 33B is a graph depicting a calibration curve for cocaine;

FIG. 33C is a graph depicting a calibration curve for hydrocodone;

FIG. 34A is a graph illustrating the relative abundance over time of an analyte showing that creatinine is identified as a primary interfering substance;

FIG. 34B is a graph illustrating the relative abundance over time of an analyte showing that creatinine is identified as a primary interfering substance;

FIG. 34C is a graph illustrating the relative abundance over time of an analyte showing that creatinine is identified as a primary interfering substance; and

FIG. 35 depicts a stacking circuit incorporating power regulation for use with a stacking device.

### DESCRIPTION OF THE ILLUSTRATIVE EMBODIMENTS

For the purposes of promoting an understanding of the principles of this disclosure, reference will now be made to a number of illustrative embodiments shown in the attached drawings and specific language will be used to describe the same.

Described herein is a device 10 comprising a paper-based microfluidic (uPAD) platform configured to couple online to high resolution mass spectrometry (HRMS) 38 via paper spray ionization (PSI) to attain orders of magnitude improvement in detection limits with broad analyte compatibility. The 3D printed cartridge 12 performs concurrent pre-concentration and ionization by integrating electrokinetic (EK) stacking techniques. Operational complexity and driving potentials are low, which minimizes expertise and material requirements. In normal paper spray, significant electrokinetic stacking or separations do not occur due to the small electric field on the paper substrate itself. Although several thousand volts are applied to the spray substrate, almost all of the voltage drop occurs across the air gap between the paper tip 26 and MS inlet 36. Because the electrical resistance of the porous substrate 16 is on the order of 1 MΩ and the current less than 1 μA, the voltage drop across the porous substrate 16 may be <1V. With a typical length of 1 cm, the resulting E field of 1 v/cm is much less than required for electrophoretic separations or stacking.

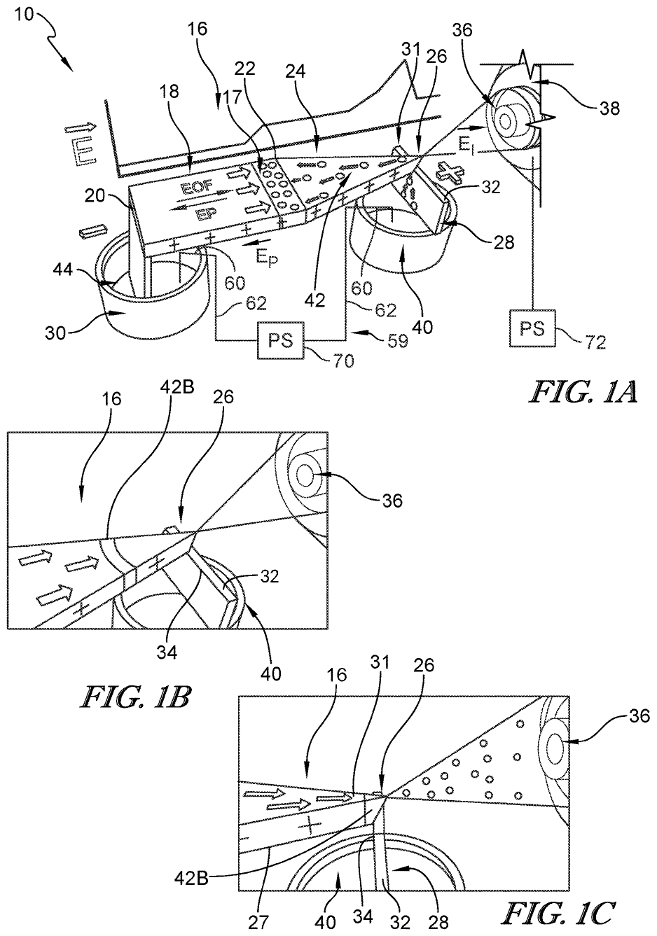

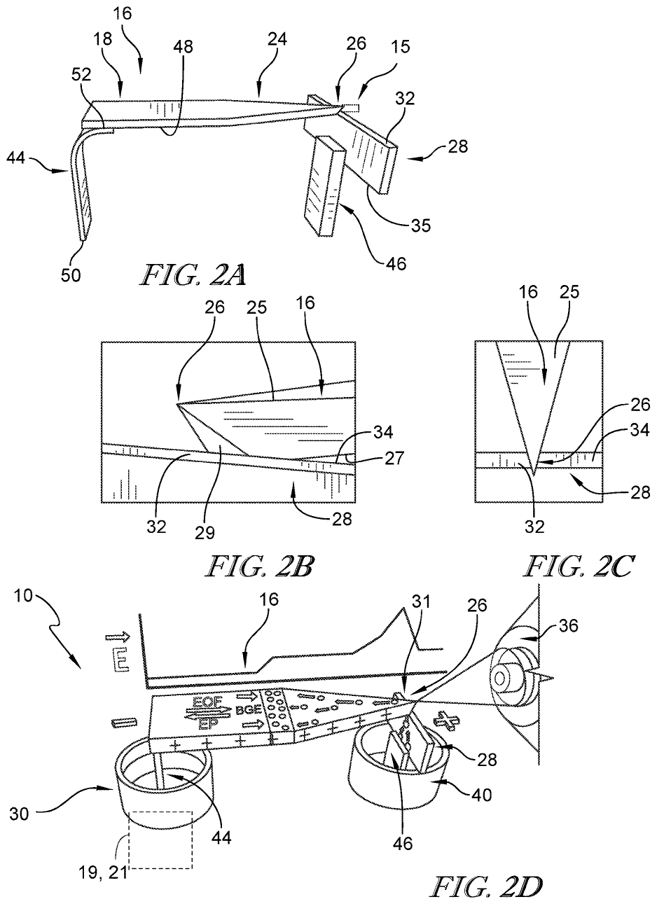

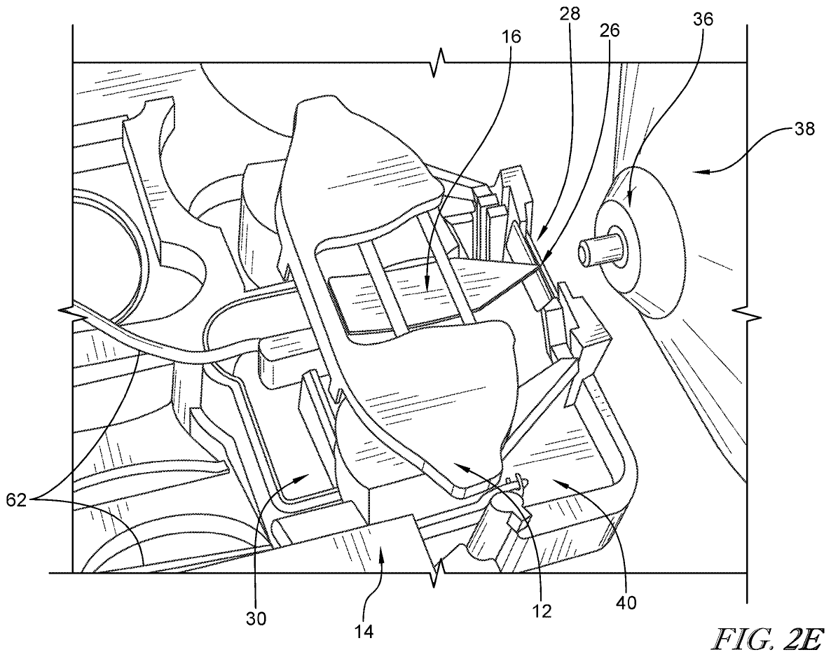

Turning to FIGS. 1A-1C and 2A-D, in some embodiments, a stacking device 10 comprises a porous substrate 16 configured to receive a sample for MS analysis. The porous substrate 16 is capable of receiving a high voltage. In some embodiments, the porous substrate 16 is a porous material comprised of fibers. In some embodiments, the porous substrate 16 is hydrophilic. In some embodiments, the porous substrate 16 is hydrophobic.

In some embodiments, the porous substrate 16 comprises a porous material selected from natural fibers, synthetic fibers, or a combination thereof. For example, the porous substrate 16 may be formed from glass fibers, a cotton swab, textile, plant tissues, papers, or a combination thereof. In some embodiments, the porous substrate 16 comprises glass fibers, which may be commercially purchased from suppliers such as CYTIVA and MILLIPORE SIGMA. The porous network or microchannels of these materials offers sufficient space to hold liquid, and the hydrophilic environment makes it possible for liquid transport by capillary action.

In some embodiments, the porous substrate 16 extends between a first end 20 and a second end 31 opposite the first end 20. The porous substrate 16 comprises an elongated body portion 18 having the first end 20 and a connection end 22 opposite the first end 20 and a tip portion 24 coupled to the connection end 22 and extending to the second end 31 as shown in FIG. 1A. The tip portion 24 tapers as the tip portion 24 extends between the connection end 22 and second end 31 thereof. The second end 31 thereof defines a spray tip 26. The spray tip 26 may be clean and free of loose or protruding fibers. In some embodiments, a capillary 15 is coupled to the spray tip 26 and extending outwardly from the tip portion 24, as shown in FIG. 2A. In some embodiments, the spray tip 26 may comprise nanofibers formed from carbon or a metal. The spray tip 26 may be configured to readily produce a Taylor cone as shown in FIG. 1C. In such embodiments including the capillary 15, the Taylor cone is produced at an exit of the capillary 15. The sharpness of the spray tip 26, the angle of the spray tip 26, and/or the thickness of the porous substrate 16 may affect the spray characteristics. The spray tip 26 of the porous substrate 16 may be configured to form a half pyramidal shape as shown in FIG. 1C and FIG. 2B. For example, the spray tip 26 may extend farther outwardly away from the tip portion 24 at a top surface 25 of the tip portion 24 than at a bottom surface 27 of the tip portion 24. In some embodiments, the spray tip 26 defines a forward surface 29, as shown in FIG. 2B, that extends between the top surface 25 and the bottom surface 27. The forward surface 29 is illustratively flat and angled relative to the top surface 25 and the bottom surface 27 (i.e., not perpendicular to the surfaces 25, 27).

As illustrated in FIGS. 1A-1C and 2A-2D, in some embodiments, the stacking device 10 comprises a voltage source connection substrate 28 configured to contact the porous substrate 16. In some embodiments, the voltage source connection substrate 28 and the porous substrate 16 are arranged perpendicular to one another. The voltage source connection substrate 28 may be configured to deliver a solvent or a sample solution to the porous substrate 16. In some embodiments, the voltage source connection substrate 28 is a porous material comprised of fibers. In some embodiments, the voltage source connection substrate 28 is hydrophilic. In some embodiments, the voltage source connection substrate 28 is hydrophobic.

In some embodiments, the voltage source connection substrate 28 comprises a porous material selected from natural fibers, synthetic fibers, or a combination thereof. For example, the voltage source connection substrate 28 may be formed from glass fibers, a cotton swab, textile, plant tissues, papers, or a combination thereof. In some embodiments, the voltage source connection substrate 28 comprises glass fibers, which may be commercially purchased from suppliers such as CYTIVA and MILLIPORE SIGMA. The porous network or microchannels of these materials offers sufficient space to hold liquid and the hydrophilic environment makes it possible for liquid transport by capillary action. In some embodiments, the voltage source connection substrate 28 may be made of the same material or different material contained in the porous substrate 16.

In some embodiments, the voltage source connection substrate 28 comprises a first surface 32 configured to contact the porous substrate 16 and a second surface 35 opposite the first surface 32 as shown in FIG. 2A. The voltage source connection substrate 28 may be shaped as an elongated body, such as a rectangle or square. In some embodiments, the voltage source connection substrate 28 contains clean corners free of protruding fibers. The voltage source connection substrate 28 may be configured so that only a lower portion of the half pyramidal spray tip 26 (i.e., the forward surface 29) of the porous substrate 16 contacts a corner 34 of the first surface 32 of the voltage source connection substrate 28. The top half of the forward surface 29 of the spray tip 26 extends over the voltage source connection substrate 28. The thickness of the voltage source connection substrate 28 may affect the spray characteristics. In some embodiments, the width of the voltage source connection substrate 28 decreases toward the point of contact with the porous substrate 16 (i.e., the width of the voltage source connection substrate 28 decreases as the voltage source connection substrate 28 extends from the second surface 35 to the first surface 32).

In some embodiments, the porous substrate 16 is in contact with the voltage source connection substrate 28, and the voltage source connection substrate 28 and the spray tip 26 are spaced apart from a charged particle inlet 36 of a charged particle separation instrument 38 to define a gap therebetween as shown in FIGS. 1A and 2D. The charged particle separation instrument 38 is configured to separate charged particles as a function of at least one molecular characteristic. The charged particle separation instrument 38 may be used with an ion source comprising the stacking device 10 disclosed herein.

In some embodiments, the charged particle separation instrument 38 is a mass spectrometer. The mass spectrometer may be of any conventional design including, for example, but not limited to a time-of-flight (TOF) mass spectrometer, a reflectron mass spectrometer, a Fourier transform ion cyclotron resonance (FTICR) mass spectrometer, a quadrupole mass spectrometer, a triple quadrupole mass spectrometer, a magnetic sector mass spectrometer, or combinations of the same. The charged particle separation instrument 38 may include any number of mass spectrometers. The ion source may comprise one or more conventional instruments for separating ions according to one or more molecular characteristics (e.g., according to ion mass, ion mass-to-charge, ion mobility, ion retention time, or the like) and/or one or more conventional ion processing instruments for collecting and/or storing ions (e.g., one or more quadrupole, hexapole and/or other ion traps), for filtering ions (e.g., according to one or more molecular characteristics such as ion mass, ion mass-to-charge, ion mobility, ion retention time and the like), for fragmenting or otherwise dissociating ions, for normalizing or shifting ion charge states, and the like. It will be understood that the ion source may include one or any combination, in any order, of any such conventional ion sources, ion separation instruments and/or ion processing instruments, and that some embodiments may include multiple adjacent or spaced-apart ones of any such conventional ion sources, ion separation instruments and/or ion processing instruments.

In some embodiments, the spray tip 26 of the porous substrate 16 is located closer to the inlet 36 of the charged particle separation instrument 38 than the voltage source connection substrate 28. When the porous substrate 16 and the voltage source connection substrate 28 are in contact, a sample applied to the porous substrate 16 may be directed to move toward and concentrate in the direction of the spray tip 26 of the porous substrate 16 as shown in FIGS. 1B and 1C.

A sample containing an analyte of interest 42 may be delivered onto the porous substrate 16 using any available means, for example, a pipette. The sample may be able to travel within the porous substrate 16. In some embodiments, the sample containing the analyte of interest 42 may be delivered onto the voltage source connection substrate 28. The sample may be able to travel within the voltage source connection substrate 28. The analyte of interest 42 may travel through the voltage source connection substrate 28 toward and into the porous substrate 16 via the point of contact between the porous substrate 16 and the voltage source connection substrate 28.

Further, as shown in FIGS. 1A and 2D, a BGE reservoir 30 of the stacking device 10 may be configured to hold a liquid. As an example, the liquid may comprise a background electrolyte (BGE) solution. The specific BGE solution used will be dependent on the sample and/or the analyte of interest 42. In some embodiments, the BGE reservoir 30 is configured to receive an electric signal. For example, an electrode assembly 59 may be coupled with a first voltage source 70, as shown in FIG. 1A. The electrode assembly 59 may include a plurality of wires 62 and a plurality of electrical contacts 60. For example, one of the plurality of wires 62 may extend toward the BGE reservoir 30, and one of the electrical contacts 60 may extend into the BGE reservoir 30.

The porous substrate 16 may be configured to couple to the BGE reservoir 30. The first end 20 of the porous substrate 16 may contact the BGE reservoir 30 or the liquid within the BGE reservoir 30. For example, the first end 20 of the porous substrate 16 may be bent to touch the BGE solution in the BGE reservoir 30. Other interactions of the porous substrate 16 with the BGE solution in the BGE reservoir 30 that do not require bending of the porous substrate 16 are also contemplated. The BGE solution is fluidly coupled to the first end 20 of the porous substrate 16.

The tip portion 24 of the porous substrate 16 and the voltage source connection substrate 28 are fluidly connected to a connection reservoir 40 of the stacking device 10 as shown in FIG. 2D. Another one of the plurality of wires 62 may extend toward the connection reservoir 40, and another one of the electrical contacts 60 may extend into the connection reservoir 40. The connection reservoir 40 may be configured to hold a liquid, such as a sample solvent, a sample solution, or BGE solution. As used herein, the term “sample solvent” refers to a solution that does not contain an analyte of interest 42. However, the term “sample solution” refers to a solution that contains an analyte of interest 42. In some embodiments, the sample solvent or sample solution may be used to ionize the analyte of interest 42 for particle spectrometry analysis. The terms “particle spectrometry” and “particle spectrometry analysis,” as used herein, should be understood to mean the measurement of one or more molecular characteristics of charged particles with any instrument or combination of instruments configured to separate and measure charged particles as a function of the one or more molecular characteristics. Examples of the one or more molecular characteristics of charged particles may include, but are not limited to, particle mass, particle charge, particle mass-to-charge ratio, particle mobility, particle retention time, or the like.

The type of sample solvent used will be dependent upon the sample and/or the analyte of interest 42. The voltage source connection substrate 28 may be coupled to the connection reservoir 40 or the solution (i.e., the sample solvent or sample solution) within the connection reservoir 40. In some embodiments, the voltage source connection substrate 28 may directly contact the solution within the connection reservoir 40 at the second surface 35 of the second substrate 28 and contact the porous substrate 16 at the first surface 32 of the voltage source connection substrate 28. Other interactions that do not require direct contact of the voltage source connection substrate 28 with the solution in the connection reservoir 40 are contemplated in this disclosure. Similar to the BGE reservoir 30 and the porous substrate 16, the analyte of interest 42 within the sample solution located within the connection reservoir 40 may travel through the voltage source connection substrate 28 via capillary action, as well as, in response to an electric signal (i.e., electrophoresis). For example, the first voltage source 70 is configured to apply a first voltage across the porous substrate 16 to establish a first electric field Ep between the first end 20 and the spray tip 26 of the porous substrate 16.

In an illustrative embodiment, a sample containing an analyte of interest 42 may be applied to the porous substrate 16. In response to the first electric field Ep across the porous substrate 16, the BGE solution flows through the porous substrate 16 with a first flow velocity in a first direction from the first end 20 of the porous substrate 16 toward the spray tip 26 of the porous substrate 16, as shown in FIGS. 1A-1C. Generally, EOF flow velocity is in the same direction as the first electric field Ep. However, as shown in FIG. 1A, the EOF flow velocity and the first electric field Ep are in opposing directions. To direct the EOF flow velocity in a direction opposite of the first electric field Ep, a positive Z-potential on the porous substrate 16 may be used. As an example, a positive Z-potential on the porous substrate 16 may be achieved using a cationic polymer, such as polyethyleneimine (PEI) or trimethoxysilylpropyl modified PEI. Electrostatic absorption of PEI onto the porous substrate 16 switches the direction of the EOF flow velocity such that the EOF flow velocity is opposite the first electric field Ep. As another example, a positive Z-potential on the porous substrate 16 may be achieved using a dipodal silane, such as (styrylmethyl)bis(triethoxysilylpropyl) ammonium chloride or N,N′-Bis(3-(trimethoxysilyl) propyl)ethylenediamine.

The flow of the BGE solution from the BGE reservoir 30 toward the spray tip 26 of the porous substrate 16 (i.e., in the first direction) occurs due to a force from EOF. The force of EOF (in other words, the first flow velocity) may be tuned, (i.e., increased or decreased depending on the strength of electrophoresis (EP)) as suggested in FIG. 1A. While the BGE solution is traveling through the porous substrate 16 in the first direction, the analyte of interest 42 may be forced to move through the porous substrate 16 in a direction toward the BGE reservoir 30 (i.e., in a second direction opposite the first direction) as suggested in FIG. 1A. The analyte of interest 42 flows through the porous substrate 16 toward the BGE solution with a second flow velocity in the second direction opposite the first direction. Upon meeting of the analyte of interest 42 with the BGE solution, an interface 17 is formed on the porous substrate 16 along which the analyte of interest 42 becomes concentrated to form a sample band 42B of the analyte of interest 42.

Without being limited by theory, it is thought that the charged molecules (i.e., the analyte of interest 42) dissolved within the sample solution or by a solvent, move through the porous substrate 16 by electrophoresis (EP) caused by an electromotive force (i.e., the force on the charged particles from the first electric field Ep). As the analyte of interest 42 is moving in the second direction toward the BGE reservoir 30, the analyte of interest 42 is met by the flow of the BGE solution on the porous substrate 16. Without being limited by theory, it is thought that when the first flow velocity (i.e., the EOF flow velocity) of the BGE solution is stronger than the second flow velocity (i.e., the electrophoresis/electrophoretic (EP) velocity) of the charged particles, the analyte of interest 42 is forced to concentrate, such as into a sample band 42B, as shown in FIG. 1B, as the analyte of interest 42 cannot move past the BGE solution. The BGE solution forces the concentrated analyte of interest 42 to move toward the spray tip 26 of the porous substrate 16 in the first direction where the analyte of interest 42 is ionized and analyzed by the charged particle separation instrument 38. In other words, the first flow velocity of the BGE solution is greater than the second flow velocity of the charged analyte of interest 42 to cause the sample band 42B to flow in the first direction toward the spray tip 26 for ionization.

The interface 17 is formed due to the boundary between the high conductivity BGE solution from the BGE reservoir 30 and the low conductivity sample solution. The interface 17 is enhanced by the titration of acetate ions electromigrating from the BGE reservoir 30 with H⁺ ions moving in the opposite direction from the connection reservoir 40. An abundance of H⁺ is present in the connection reservoir 40 from both the addition of acetic acid and electrolysis of water at the connection reservoir 40. Continuous titration of the BGE solution as it saturates the porous substrate 16 forms a narrow leading zone of low conductivity and a steep electric field gradient.

A means for controlling a flow rate of the BGE solution to the first end 20 of the porous substrate 16 is also provided herein. The means for controlling the flow rate of the BGE solution control a magnitude of the first flow velocity relative to a magnitude of the second flow velocity in a manner which moves the sample band 42B of the analyte of interest 42 toward the spray tip 26. For example, the magnitude of the first flow velocity may be tuned by the width of the porous substrate 16. As another example, the magnitude of the first flow velocity may be tuned by including the flow substrate 44. The flow substrate 44 may comprise a low flow rate filter paper. The flow substrate 44 limits solvent transfer onto the porous substrate 16. The flow substrate 44 is connected to the porous substrate 16, which has a higher flow rate, so that the total flow rate is limited by the flow substrate 44. The flow substrate 44 prevents full saturation of the porous substrate 16. The porous substrate 16 transfers solvent to the voltage source connection substrate 28 faster than the porous substrate 16 receives the solvent from the flow substrate 44. See Example 12 below. As another example, a width of the flow substrate 44 may be adjusted to tune the magnitude of the first flow velocity. An another example, a pump 21 may be used with the device 10 to tune the magnitude of the first flow velocity by controlling the flow rate of the BGE solution onto the porous substrate 16. An another example, environmental conditions of the BGE reservoir 30 and/or the BGE solution may be controlled to tune the magnitude of the first flow velocity. For example, the device 10 may include a temperature control unit 19 that cools and/or heats the BGE reservoir 30 and/or the BGE solution relative to room temperature such that a viscosity of the BGE solution is adjusted, as shown in FIG. 2D. For example, as the viscosity increases, the flow rate of the BGE solution onto the porous substrate 16 is decreased.

As another example, the Z-potential of the porous substrate 16 may be adjusted as a means for controlling a flow rate of the BGE solution. The Z-potential on the porous substrate 16 may be adjusted via processing and/or treating the porous substrate 16, as described above. As another example, the components of the BGE solution may be selected so as to control the permittivity and/or the viscosity of the BGE solution.

The first flow velocity (i.e., the EOF flow velocity) is defined by the following equation:

$${μ}_{EOF} = - \frac{- {εζ}_{0} E}{μ} ,$$

where ε(F/m) is the relative permittivity of the fluid, ζ₀ (V) is the zeta potential of the porous substrate 16, E (V/m) is the electric field, and μ (N s/m²) is the dynamic viscosity of the fluid. Thus, the relative permittivity and the viscosity of the BGE solution may be adjusted to control a flow rate of the BGE solution.

The first voltage source 70 is configured to establish a first voltage at the spray tip 26 of the porous substrate 16, and a second voltage source 72 is configured to establish a second voltage at the charged particle inlet 36 of the charged particle separation instrument 38 so as to establish a second electric field E between the spray tip 26 of the stacking device 10 and the charged particle inlet 36 of the charged particle separation instrument 38. The second electric field Ei causes the spray tip 26 to spray charged particles of the analyte of interest 42 toward and into the inlet 36 of the charged particle separation instrument 38.

In some embodiments, the voltage source connection substrate 28 or the connection reservoir 40 may contain sample solvent to keep the spray tip 26 wet, which may help with ionization. This technique allows for the analysis of the analyte of interest 42 present in very small quantities within a sample. The voltage source connection substrate 28 also allows for excess solvent to flow down the voltage source connection substrate 28 instead of pooling on the porous substrate 16.

In some embodiments, a sample solution containing the analyte of interest 42 is deposited onto the voltage source connection substrate 28 directly or deposited into the connection reservoir 40 as suggested in FIG. 1A. As before, when the first voltage is applied, the analyte of interest 42 within the sample solution becomes charged and may begin to travel through the voltage source connection substrate 28 and into the porous substrate 16 through the point of contact at the corner 34 between the porous substrate 16 and the voltage source connection substrate 28. In some embodiments, the analyte of interest 42 is forced to travel in the direction toward the BGE reservoir 30 due to EP. As before, the direction of travel of the analyte of interest 42 is forced to change when the analyte of interest 42 meets the BGE solution on the porous substrate 16. When the EOF flow velocity of the BGE solution is stronger than the EP flow velocity, the concentrated analyte of interest 42 is forced to move toward the spray tip 26 where the analyte of interest 42 may be ionized and analyzed by the charged particle separation 38.

In some embodiments, the stacking device 10 comprises additional substrates 44, 46 as shown in FIGS. 2A and 2D. The substrates 44, 46 may be made of the porous materials previously mentioned for the porous substrate 16 and the voltage source connection substrate 28. In one example, as shown in the FIG. 2D, a flow substrate 44 may be used to couple the BGE reservoir 30 to the porous substrate 16. In some embodiments, a connector substrate 46 may be used to couple the connection reservoir 40 to the voltage source connection substrate 28. In some embodiments, the BGE reservoir 30 is coupled to the flow substrate 44, the flow substrate 44 is coupled to the porous substrate 16, the porous substrate 16 is coupled to the voltage source connection substrate 28, the voltage source connection substrate 28 is coupled to the connector substrate 46, and the connector substrate 46 is coupled to the connection reservoir 40. The use of additional reservoirs and additional substrates are also contemplated in this disclosure.

In some embodiments, the voltage source connection substrate 28 may contact the connector substrate 46 so that the connector substrate 46 couples the connection reservoir 40 and the voltage source connection substrate 28. The voltage source connection substrate 28 may directly contact the connector substrate 46. For example, the voltage source connection substrate 28 and the connector substrate 46 may be configured into rectangles. Additionally, the voltage source connection substrate 28 or the connector substrate 46 may be cut or modified to allow the two pieces to fit together, similar to a tongue-and-groove or puzzle pieces. In some embodiments, the connector substrate 46 has a narrower width compared to the voltage source connection substrate 28 as shown in FIG. 2A. In some embodiments, the connector substrate 46 has a gradually narrower width as it approaches the point of contact with the voltage source connection substrate 28. In some embodiments, the voltage source connection substrate 28 may have a narrowed width at the point of contact with the connector substrate 46.

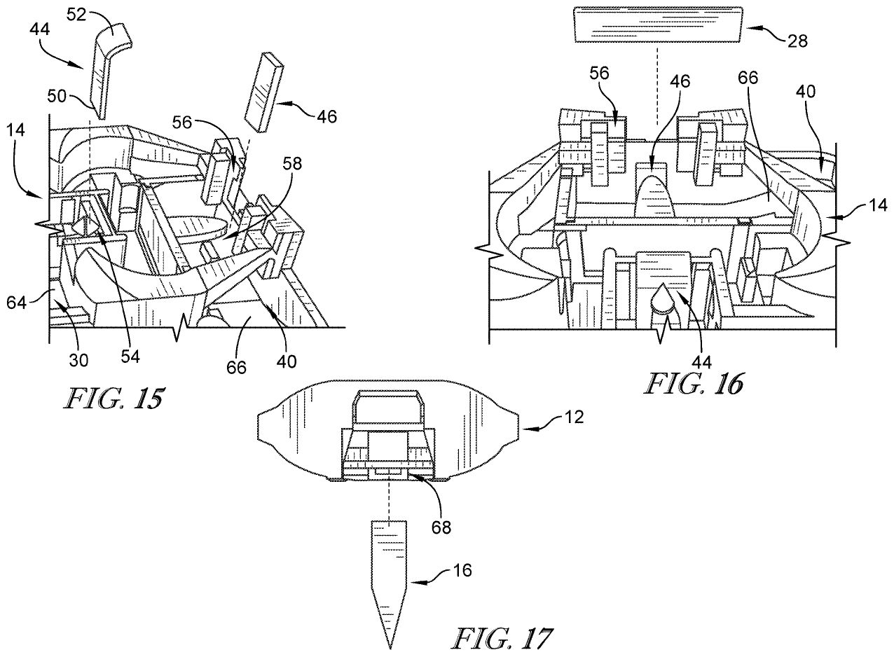

In some embodiments, the porous substrate 16 may contact the flow substrate 44 so that the flow substrate 44 couples the BGE reservoir 30 to the porous substrate 16. The porous substrate 16 may directly contact the flow substrate 44. For example, the flow substrate 44 may be in contact with the BGE solution at a first end 50 thereof. A second end 52 of the flow substrate 44 may slightly bent toward the substrates 28, 46 to contact a lower surface 48 of the porous substrate 16 as shown in FIGS. 2A and 15. Additional means to contact the flow substrate 44 with the porous substrate 16 are contemplated in this disclosure. In some embodiments, the flow substrate 44 has a narrower width compared to the porous substrate 16. In some embodiments, the flow substrate 44 has a gradually narrower width as it approaches the point of contact with the porous substrate 16. In some embodiments, the porous substrate 16 may have a narrowed width at the point on contact with the flow substrate 44.

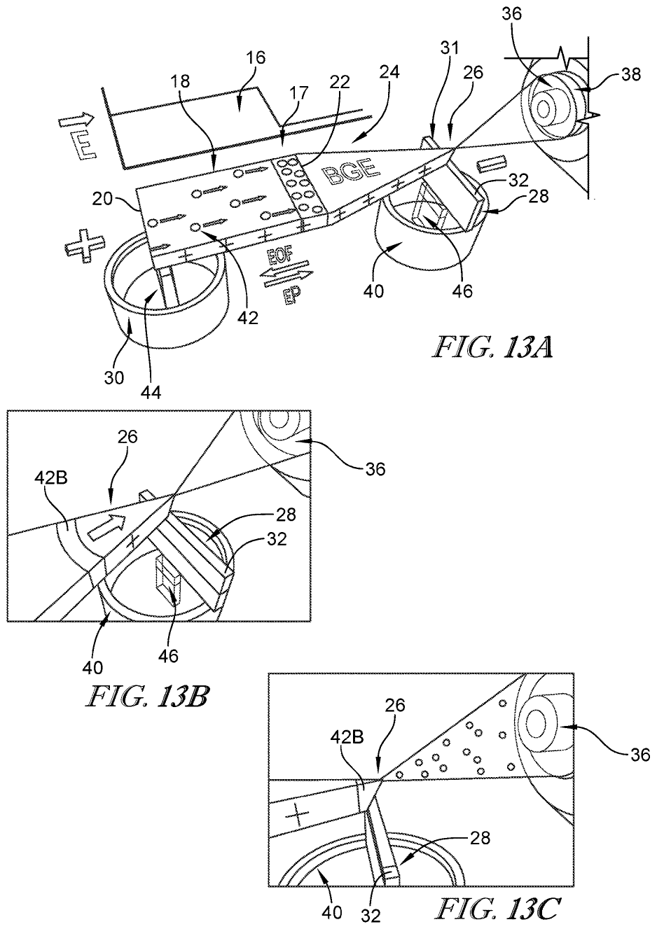

Turning to FIGS. 13A, 13B, and 13C, the sample solution may be deposited into a connector reservoir 30 (as opposed to the connector reservoir 40 as shown in FIG. 1A), or the sample containing the analyte of interest 42 may be deposited onto the porous substrate 16. In this embodiment, the BGE solution is deposited into the BGE reservoir 40. The BGE solution is fluidly coupled to the second end 31 of the porous substrate 16. Once the first voltage is applied, the BGE solution flows through the porous substrate 16 with a first flow velocity in a first direction from the second end 31 of the porous substrate 16 toward the first end 20 of the porous substrate 16. The analyte of interest 42 becomes charged and flows through the porous substrate 16 toward the BGE solution in the BGE reservoir 40 with a second flow velocity in a second direction opposite the first direction. Upon meeting of the analyte of interest 42 with the BGE solution, an interface 17 is formed on the porous substrate 16 along which the analyte of interest 42 becomes concentrated to form a sample band 42B of the analyte of interest 42, as shown in FIG. 13B. In this embodiment, the second flow velocity (i.e., the EP flow velocity) is stronger than the first flow velocity (i.e., the EOF flow velocity) so that the analyte of interest 42 can travel to the spray tip 26 and form the Taylor cone, as shown in FIG. 13C. In other words, the EOF flow velocity of the BGE solution is less than the EP flow velocity of the charged analyte of interest 42 to cause the sample band 42B to flow toward the spray tip 26 for ionization. As discussed further in the Examples, the force of the flow of the BGE solution and the EP of the charged analyte of interest 42 may be tuned to increase or decrease as needed to concentrate and analyze the sample. In such an embodiment, the substrate 44 acts as the voltage source connection substrate 44, the substrate 28 acts as the flow substrate 28, and the substrate 46 acts as the connector substrate 46.

In one example, as shown in the FIG. 13A, the voltage source connection substrate 44 may be used to couple the connection reservoir 30 to the porous substrate 16. In some embodiments, the connector substrate 46 may be used to couple the BGE reservoir 40 to the flow substrate 28. In some embodiments, the connection reservoir 30 is coupled to the voltage source connection substrate 44, the voltage source connection substrate 44 is coupled to the porous substrate 16, the porous substrate 16 is coupled to the flow substrate 28, the flow substrate 28 is coupled to the connector substrate 46, and the connector substrate 46 is coupled to the BGE reservoir 40. The use of additional reservoirs and additional substrates are also contemplated in this disclosure.

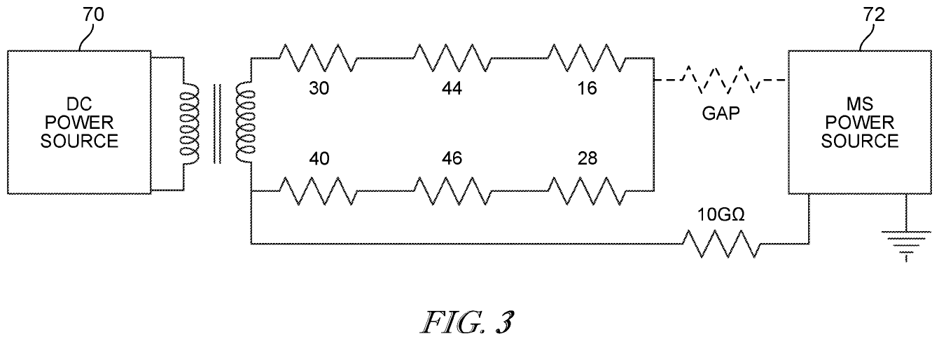

Turning to FIGS. 1A and 3, an exemplary schematic of electrical components is demonstrated for use with the stacking device 10. In some embodiments, a single voltage source may be used to generate paper spray ionization (PSI) and sample stacking (i.e., concentrating the sample into a band). In some embodiments, at least two voltage sources 70, 72 may be used where a first power source 72 is used for paper spray ionization and a second power source is used for the sample stacking. By tuning the parameters of each the voltage sources 70, 72, the EOF flow velocity of the BGE solution and/or the EP flow velocity of the charged analyte of interest 42 can be controlled to concentrate the sample or substance of interest within the sample and move the concentrated sample to the spray tip 26 of the porous substrate 16 for ionization and MS analysis.

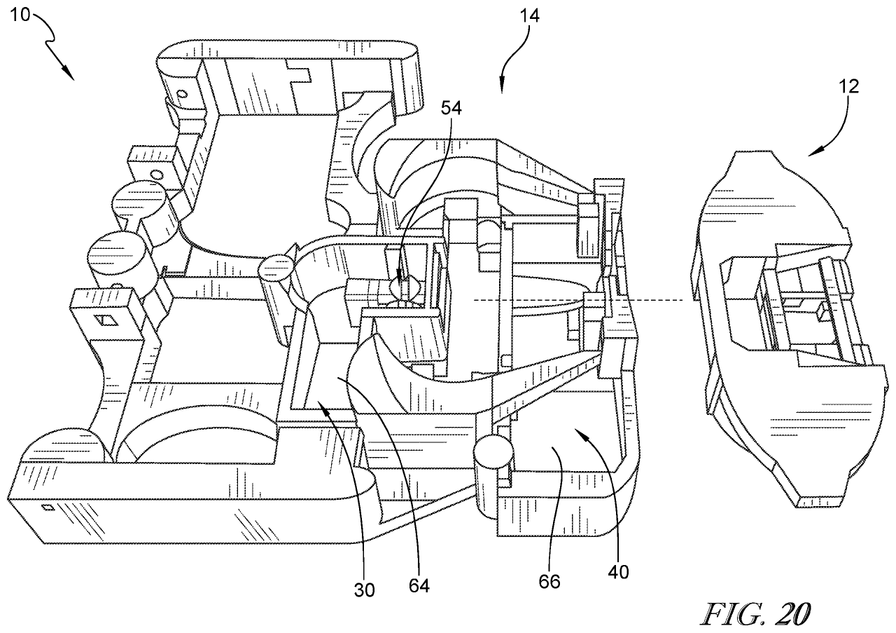

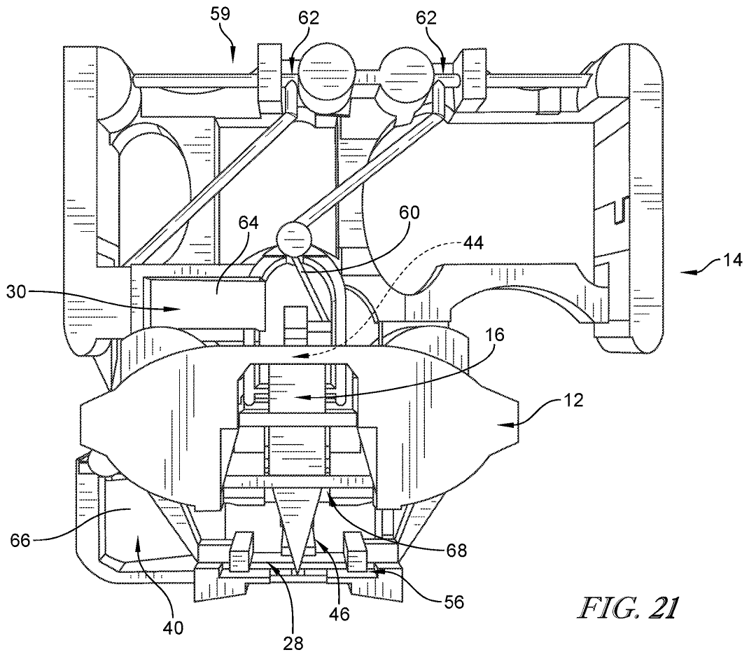

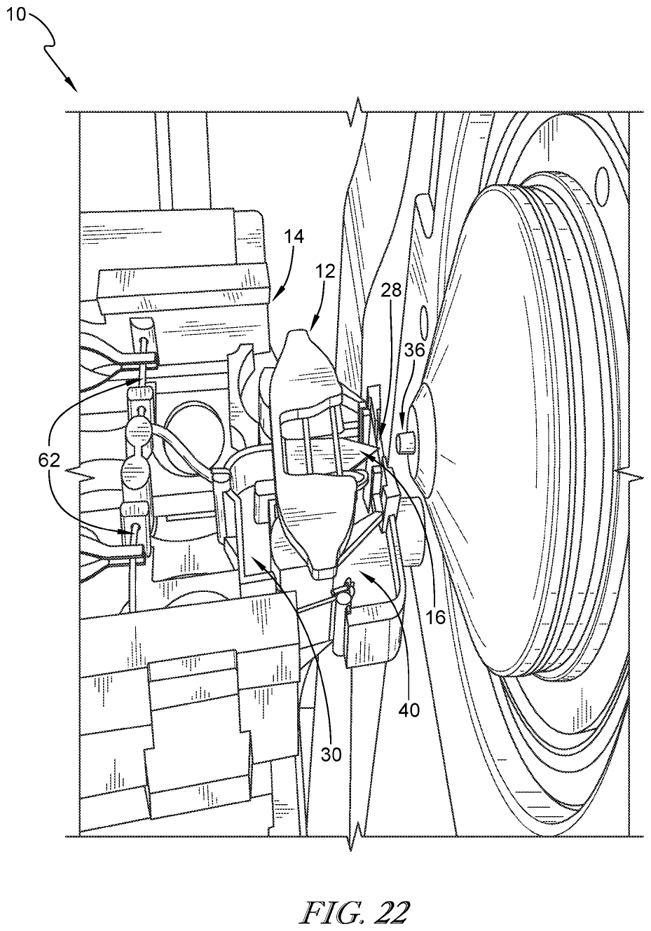

As shown in FIGS. 2E and 16-22, the stacking device 10 includes a cartridge 12 and a base 14 configured to stabilize the substrates 16, 28, 44, 46. In some embodiments, the base 14 includes the reservoirs 30, 40. The base 14 may be configured to stabilize and/or hold the substrates 16, 28, 44, 46 as the substrates 16, 28, 44, 46 contact the solutions in the reservoirs 30, 40. In some embodiments, the base 14 includes a means, such as a slot 54, to stabilize and/or hold the substrate 44 while the substrate 44 is in contact with the solution in the reservoir 30, as shown in FIGS. 15 and 16. The substrate 44 may be moved downwardly into the slot 54. In some embodiments, the base 14 includes a means, such as a slot 56, to stabilize and/or hold the substrate 28 while the substrate 28 is in contact with the substrate 46 or in contact with the sample solvent in the reservoir 40, as shown in FIGS. 16 and 16. The substrate 28 may be moved downwardly into the slot 56. In some embodiments, the base 14 includes a means, such as a slot 58, to stabilize the substrate 46 while the substrate 46 is in contact with the sample solvent of the reservoir 40 and the substrate 28. The substrate 46 may be moved downwardly into the slot 58.

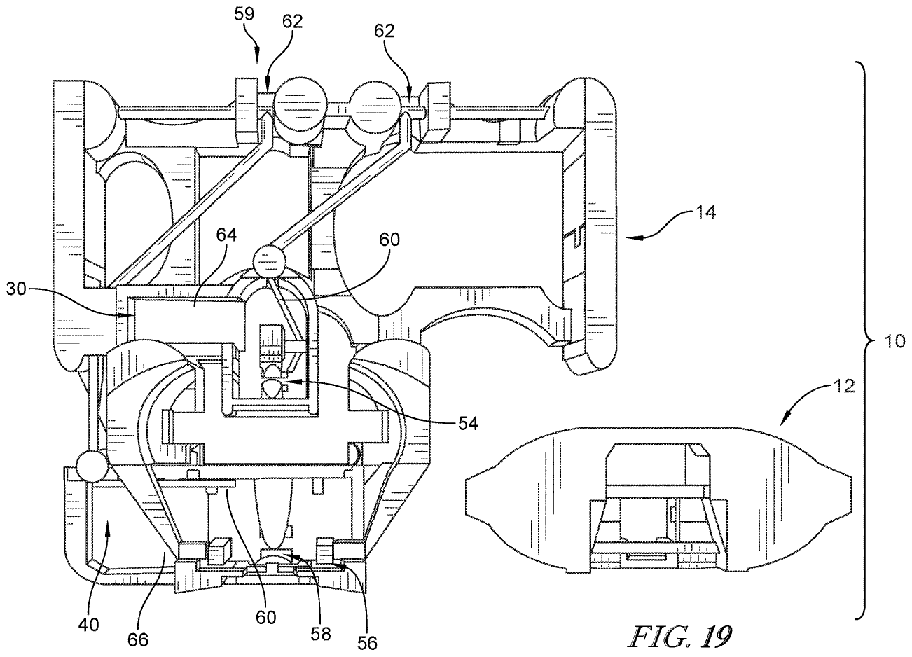

The stacking device 10 further includes an electrode assembly 59 comprising at least two electrical contacts 60 and at least two wires 62 as shown in FIGS. 19, 21, and 22. The electrical contacts 60 extend into the reservoirs 30, 40 and the wires 62 are in electrical communication with the electrical contacts 60 and at least one voltage source 70, 72.

The reservoirs 30, 40 may be positioned so that the BGE solution or the sample solvent may be added to each reservoir 30, 40 without disturbing the substrates 16, 28, 44, 46, as suggested in FIG. 2E. For example, the reservoirs 30, 40 may have openings that are easily accessible even when the cartridge 12 is in place. Additionally, the reservoirs 30, 40 may each contain an angled wall 64, 66 that slopes at an angle to direct the BGE solution or the sample solvent down into the reservoir 30, 40 toward the substrates 16, 28, 44, 46 so that a small amount of liquid may be directed toward the substrates 16, 28, 44, 46 without over-saturating the substrates 16, 28, 44, 46.

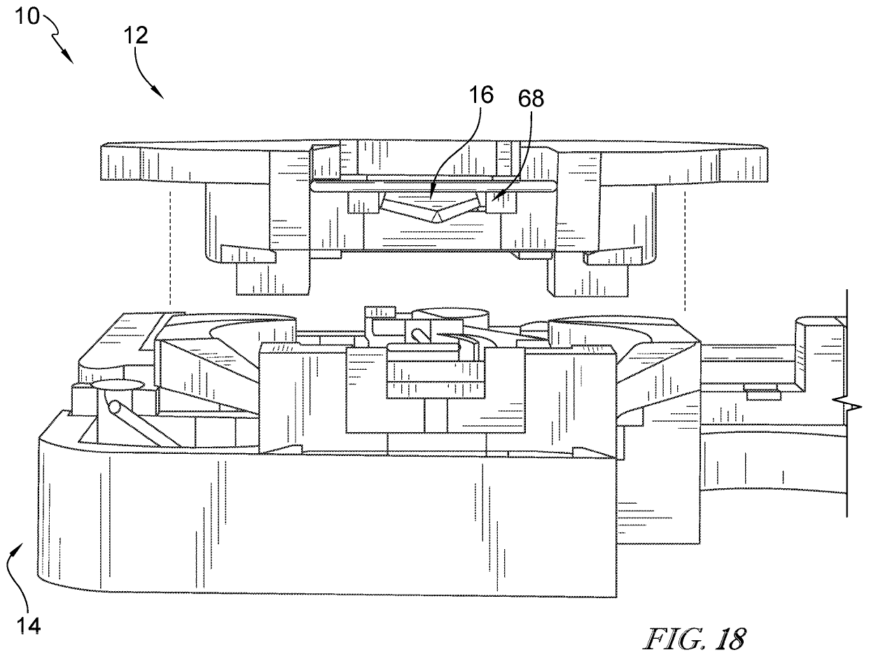

The cartridge 12 is configured to couple and decouple from the base 14 and stabilize and/or hold the porous substrate 16 as shown in FIG. 18. In other words, the cartridge 12 is removably coupled to the base 14. The cartridge 12 may align with the base 14 so that the porous substrate 16 may contact the BGE reservoir 30 or the flow substrate 44 as desired. Additionally, the cartridge 12 may align with the base 14 so that the spray tip 26 of the porous substrate 16 may contact the voltage source connection substrate 28 in a manner that allows for sample solvent to flow from the connection reservoir 40 to the voltage source connection substrate 28 to the porous substrate 16. The cartridge 12 is formed to include a slot 68 to receive the first substrate 16 therein.

In some embodiments, the base 14 includes a means to raise and lower the cartridge 12 so that the Taylor cone is in the optimal position relative to the inlet 36. In some embodiments, the base 14 includes a means to adjust the distance between the spray tip 26 of the porous substrate 16 and the inlet 36. Additionally, in some embodiments, the base 14 includes a means for adjusting the horizontal alignment of the porous substrate 16 to improve the contact with the substrates 28, 44.

The cartridge 12 and the base 14 may be formed out of any material suitable for particle spectrometry analysis. Ideally, the material is inert, easy to clean, and ergonomic. In some embodiments, the cartridge 12 and the base 14 are manufactured using a 3D printer. Additional details on this process can be found in the Examples. Other means of manufacture are also contemplated in this disclosure.

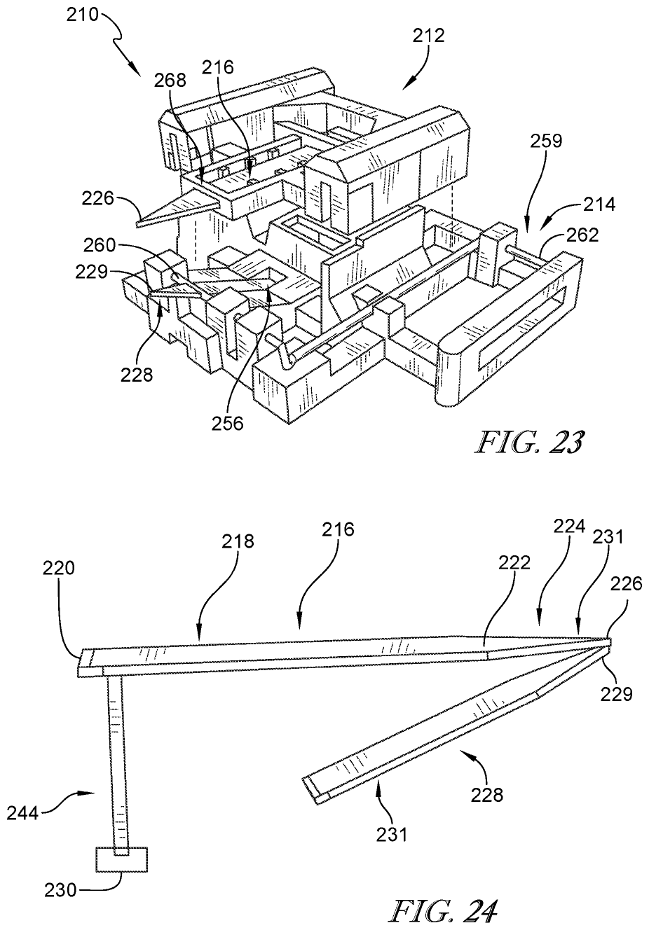

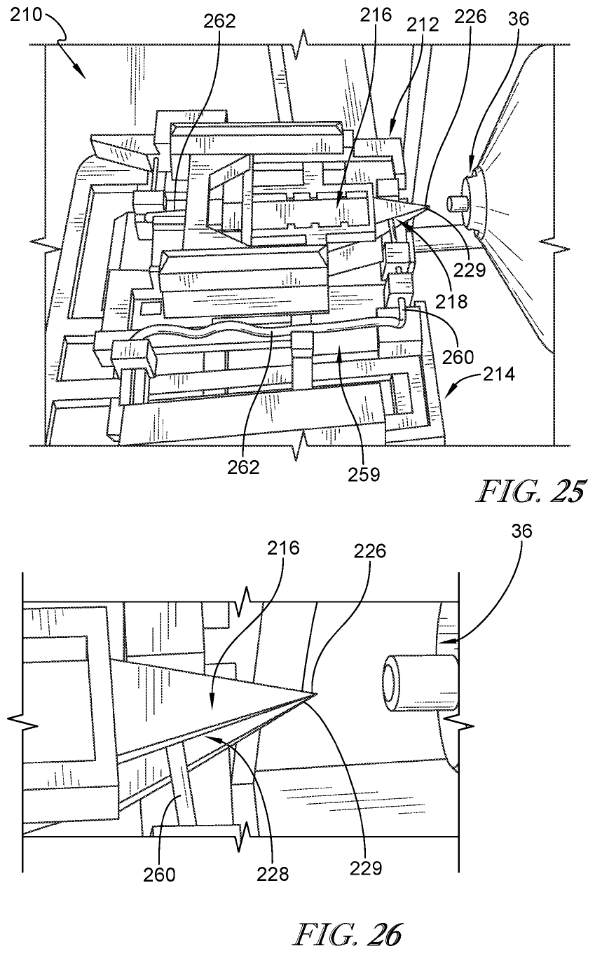

In some embodiments, as shown in FIGS. 23 and 24, a stacking device 210 comprises a cartridge 212 and a base 214. The stacking device 210 further comprises substrates 216, 228, 244. In some embodiments, the porous substrate 216 extends between a first end 220 and a second end 231 thereof. The porous substrate 216 comprises an elongated body portion 218 having the first end 220 and a connection end 222 opposite the first end 220 and a tip portion 224 coupled to the connection end 222 and extending to the second end 231. The tip portion 224 tapers as the tip portion 224 extends between the connection end 222 and the second end 231. The second end 231 defines a spray tip 226 thereof.

The angled substrate 228, which may act as the flow substrate or the voltage source connection substrate, comprises an elongated body portion 232 that tapers as the elongated body portion 232 extends to a tip 229 thereof as shown in FIG. 24. The sharp tip 229 of the angled substrate 228 contacts the spray tip 226 of the porous substrate 216. The angled substrate 228 is angled relative to the spray tip 226. Illustratively, the angled substrate 228 and the porous substrate 216 are not perpendicular to one another. The angling of the substrates 216, 228 and shape of the sharp tip 229 reduces the impact of the angled substrate 228 on the second electric field Ei formed between the mass spectrometer 38 and the porous substrate 216.

Optimal ionization may occur when employing laser cutting to shape substrates 216, 228 such that both contain sharp tips 226, 229 that converge toward one another at an angle. In some embodiments, an angle of about 0 degrees to about 90 degrees is formed between substrates 216, 228. In some embodiments, an angle of about 30 degrees is formed between substrates 216, 228. In some embodiments, an angle of about 0 degrees is formed between substrates 216, 228. In such an embodiment, the substrates 216, 228 are separated with a thin, impermeable, nonconductive material, such as a thin plastic sheet, configured to prevent solvent from flowing between the substrates 216, 228 except at the sharp tips 226, 229 that contact one another. E-field interference from the angled substrate 228 in this configuration is minimal, allowing for placement of the spray tip 226 directly in front of the inlet 36 with minimized adverse effect on ionization efficiency. This configuration may be beneficial for MS ionization because the angled substrate 228 does not negatively affect the electrospray field.

In some embodiments, the stacking device 210 comprises an additional substrate 244. In one example, as shown in the FIGS. 23 and 24, a substrate 244, which may act as the flow substrate or the voltage source connection substrate, may be used to couple a reservoir 230, which may act as the BGE reservoir or the connection reservoir, to the porous substrate 216. In some embodiments, the reservoir 230 is coupled to the substrate 244, the substrate 244 is coupled to the porous substrate 216, and the porous substrate 216 is coupled to the angled substrate 228.

The stacking device 210 includes the cartridge 212 and the base 214 configured to stabilize the substrates 216, 228, 244. In some embodiments, the base 214 includes the reservoir 230. The base 214 may be configured to stabilize and/or hold the substrates 228, 244. In some embodiments, the base 214 includes a means, such as a slot, to stabilize and/or hold the substrate 244 while the substrate 244 is in contact with the BGE solution in the reservoir 230, similar to slot 54 previously described. In some embodiments, the base 214 includes a means, such as a slot 256, to stabilize and/or hold the angled substrate 228 while the angled substrate 228 is in contact with the porous substrate 216.

The stacking device 210 further includes an electrode assembly 259 comprising at least two electrical contacts 260 and at least two wires 262. The electrical contacts 260 extend into the reservoir 230 and/or into contact with the angled substrate 228, as shown in FIG. 23. The wires 262 are in electrical communication with the electrical contacts 260 and at least one power source.

The cartridge 212 is configured to couple and decouple from the base 214 and stabilize and/or hold the porous substrate 216 as shown in FIG. 23. The cartridge 212 may align with the base 214 so that the porous substrate 216 may contact the reservoir 230 or the substrate 244 as desired. Additionally, the cartridge 212 may align with the base 214 so that the spray tip 226 of the porous substrate 216 may contact the angled substrate 228. The cartridge 212 is formed to include a slot 268 to receive the porous substrate 216 therein.

In alternative embodiments, faradaic ion concentration polarization (f-ICP) may be used instead of FASS. A range of configurations of substrate 16, 28, 44, 46, 216, 228, 244 are feasible for both stacking approaches (FASS and f-ICP). F-ICP is useful for stacking samples with a high salt concentration, such as urine or other biological fluids.

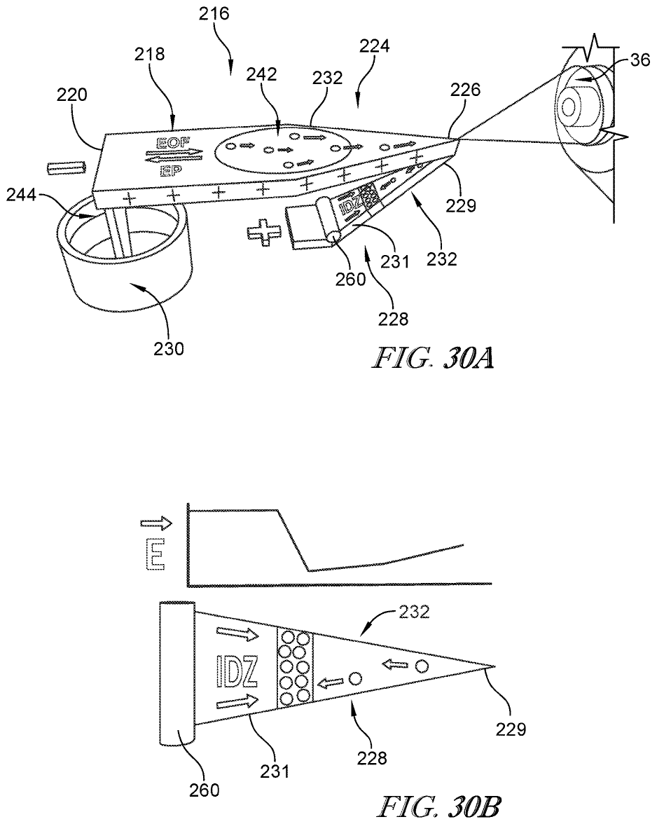

For f-ICP stacking, precision laser cutting may be employed to prepare the substrates 216, 228, 244. Precision laser cutting and careful assembly may be useful to achieve symmetric convergence of the two substrates 216, 228, as shown in FIGS. 26 and 30A. The angled substrate 228 may be narrower than the porous substrate 216, may have a steeper angled tip, and may extend at least 1 cm beyond the anode (i.e., the electrical contact 260 as shown in FIGS. 30A and 30B).

In some embodiments, the angled substrate 228 may be bent as shown in FIG. 30A. The electrical contact 260 directly contacts the angled substrate 228 at the bend of the angled 228. A high-conductivity sample solution 242 is deposited on the porous substrate 216, and a low conductivity BGE solution may be held in the BGE reservoir 230. In some embodiments, the BGE solution may consist of 20 mM ammonium acetate in 70:29:1 MeOH:H2O:CH3COOH (v:v:v). The BGE solution is used to wet the paper channel (i.e., substrates 244, 216, 228). Cations from the sample solution 242 deposited on the porous substrate 216 migrate with the EOF flow velocity to the boundary of an ion-depletion zone (IDZ) 231 formed at the electrical contact 260 (i.e., the cations move in a first direction). For example, the sample solution 242 travels within the porous substrate 216, to the angled substrate 228, and to the IDZ 231 as shown in FIGS. 30A and 30B.

Application of 400 V across the paper channel (i.e., substrates 244, 216, 228) induces the stacking of the sample 242 near the electrical contact 260, followed by slow migration of the sample band through the angled substrate 228 onto the spray tip 226 of the porous substrate 216 (i.e., migration of the sample band in a second direction opposite the first direction). Stacking of the sample 242 and subsequent movement toward the spray tip 226 coincides with the formation and propagation of the IDZ 231 formed due to protonation of acetate.

In f-ICP, the driving principle is the acid-base neutralization of BGE ions to establish a zone of significantly reduced conductivity. Following application of 400 V, water oxidation at the electrical contact 260 yields protons that neutralize acetate ions to create the IDZ 231 adjacent the electrical contact 260. A steep electric field gradient forms at the boundary of the IDZ 231 so that the analyte of interest 242 moves from the porous substrate 216 (due to EOF) and stacks at the boundary of the IDZ 231 on the angled substrate 228. EOF counterflow maintains the sharpness of the IDZ boundary 231 as it expands over time. In this mode, the BGE concentration is lower than in FASS to allow the IDZ boundary 231 to gradually propagate toward the spray tip 226 from the angled substrate 228. The stacking device 210 is floated at 4.0 kV, for example, relative to the inlet 36 of the mass spectrometer 38 when employing a design with converging tips 226, 229.

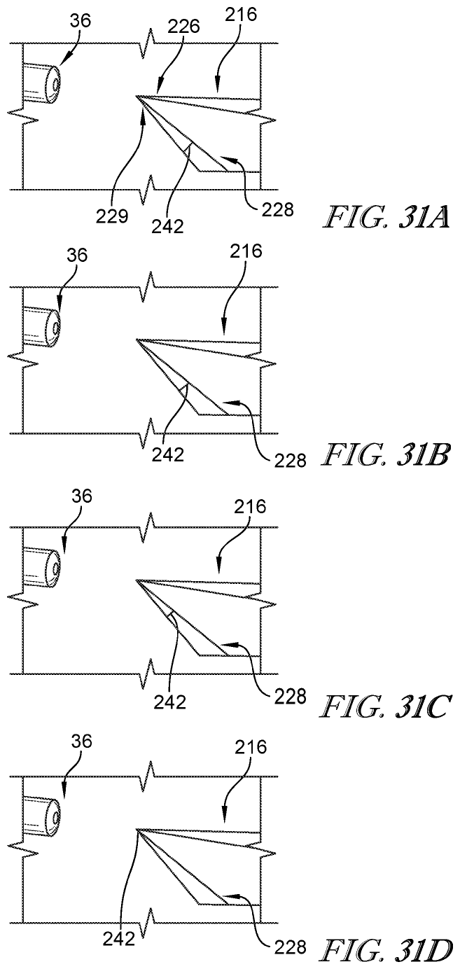

As shown in FIGS. 31A-31D, the sample 242 migrates to the boundary of the ion-depletion zone (IDZ) 231 on the angled substrate 228 as shown in FIG. 31A. The sample 242 then migrates through the angled substrate 228 toward the tip 229 thereof, as shown in FIGS. 31B and 31C. The sample 242 then migrates onto the spray tip 226 of the porous substrate 216, as shown in FIG. 31D.

For f-ICP stacking of urine samples, BGE concentrations as low as 5 mM may be effective. However, achieving narrow analyte bands in less than 10 minutes typically requires BGE concentrations greater than or equal to 20 mM, presumably due to urine anions affecting the f-ICP. While high levels of bicarbonate in urine enhance f-ICP, chloride, the most abundant anion, does not participate in acid-base neutralization reactions. Other anions such as sulfates and phosphates are only partially depleted. While chloride is neutralized directly at the electrical contact 260 through oxidation, this reaction occurs independently of the BGE titration and in a different location. Furthermore, as electrochemical oxidation of chloride is more favorable compared to water, the electrical contact 260 may initially allocate more reactive capacity to the chloride, delaying the formation of the IDZ 231.

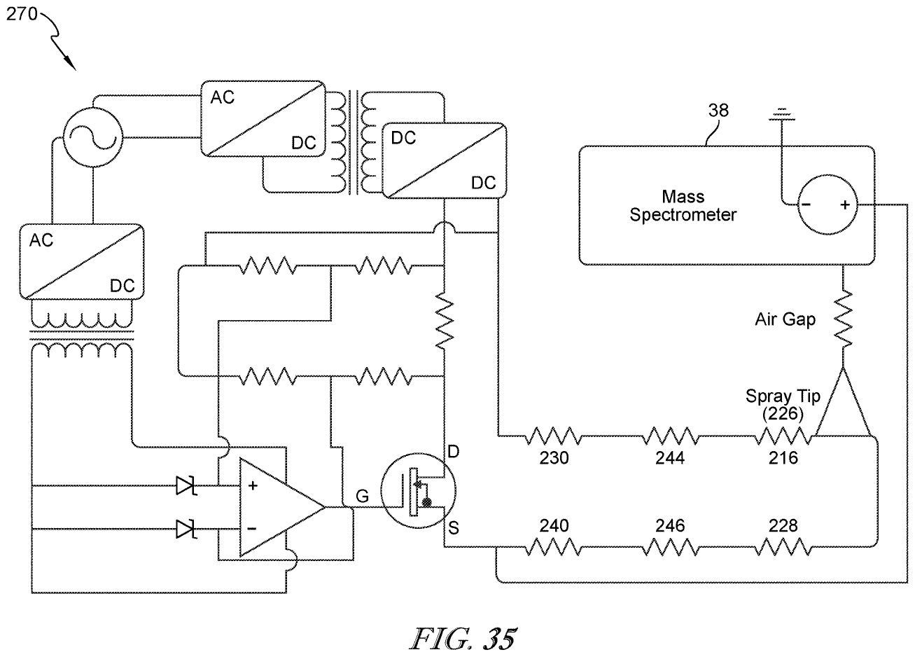

The stacking device 210 may comprise a power regulation circuit 270 as shown in FIG. 35. The electrical resistance of the stacking device 210 can change depending on the salt concentration of the sample 242 and the volume of sample 242 added to the stacking device 210. The power regulation circuit 270 adjusts the voltage to keep the electrical current from exceeding desired levels and limits Joule heating effects.

When operating the electrokinetic stacking procedure at a constant voltage, there is a risk that the electrical current will be higher than optimal. Higher than normal current can occur, for example, because of high salt concentrations in the sample 242 which decrease electrical resistance. High currents can lead to undesirable increase in temperatures of the substrate 216, 228, 244 and solvents due to Joule heating. To make the stacking device 210 more robust with respect to salt concentrations, and to remove the need for monitoring the current and manually adjusting the voltage, the power regulation circuit 270 is included in the stacking device 210 to maintain the power level, and therefore, the stacking device 210 temperature at an appropriate level.

### Methods of Use

Methods of analyzing the analyte of interest 42, 242 via mass spectrometry are disclosed. The analyte of interest 42, 242 may be present in a sample. A sample may be a fluid, solid, semi-solid, or a combination thereof. The sample may come from the environment such as water from a faucet, pond, or lake; or the sample may be from soil, an oil field, a cave, or a mine. Alternatively, the sample may come from an organism such as a yeast, a bacterium, a bacteria film, a fungus, a virus, or an animal such as a human, farm animal, domesticated animal, wild animal, amphibian, or fish. In some embodiments, the sample is pre-processed prior to contacting the porous substrate 16, 216 or the substrate 28, 228. In some embodiments, the pre-processed analyte of interest 42, 242 is provided in a sample solution and deposited into the reservoir 30, 230 or the reservoir 40. For example, pre-processing may involve pre-concentrating the analyte of interest 42, 242. Methods and devices for pre-concentrating the analyte of interest 42, 242 are described in U.S. Patent Publications US2021/0387175, US2021/0296106, and US2022/0406587, the contents of each of incorporated by reference herein in their entirety. In some embodiments, the sample 42, 242 is unprocessed and applied directly to the porous substrate 16, 216 or the substrate 28, 228, or deposited in the reservoir 30, 230 or the reservoir 40, 240 as a sample solution.

In some embodiments, the substrates 16, 28, 44, 46, 216, 228, 244 are assembled into the cartridge 12, 212 and base 14, 214. The porous substrate 16, 216 is inserted into the slot 68, 268 of the cartridge 12, 212 and at least the voltage source connection substrate 28, 228 is placed in the base 14, 214. In some embodiments, the flow 44, 244 is inserted in the BGE reservoir 30, 230 and the connector substrate 46 is inserted in the connection reservoir 40 and in contact with the voltage source connection substrate 28. A BGE solution is added to the BGE reservoir 30 while sample solvent or sample solution is added to the connector reservoir 40. The types of solutions used will be dependent upon the sample and analyte of interest 42. The solutions may be added to the reservoirs 30, 40, 230 before the substrates 28, 44, 46, 228, 244 are placed within the base 14, 214 or the solutions may be added to the reservoirs 30, 40, 230 after the substrates 28, 44, 46, 228, 244 have been placed. Alternatively, the solutions may be directly applied to their respective substrate 16, 28, 44, 46, 216, 228, 244 without the use of reservoirs 30, 40, 230. Once the substrates 16, 28, 44, 46, 216, 228, 244 are placed within the base 14, 214 and the cartridge 12, 212, the cartridge 12 212 may then be coupled to the base 14, 214 so that the porous substrate 16, 216 contacts at least the voltage source connection substrate 28, 228. Additionally, the cartridge 12, 212 may be aligned so that the porous substrate 16, 216 is in contact with the flow substrate 44, 244 and the voltage source connection substrate 28, 228.

In some embodiments, a sample may be pre-mixed with the solvent to form a sample solution or the sample may be applied to (i.e., directly contact) the porous substrate 16, 216 without pre-mixing. The spray tip 26, 226 of the porous substrate 16, 216 may be configured so that an ionized sample forms a Taylor cone toward the inlet 36 of the mass spectrometer 38. The sample containing the analyte of interest 42, 242 may be applied to the porous substrate 16, 216 near the middle of the top surface and not at the spray tip 26, 226. Sample placement on the porous substrates for mass spectrometry analysis is well known in the art. A person having ordinary skill in the art would be able to understand where to place a sample containing an analyte of interest 42, 242 and may be able to adjust where the sample is applied to porous substrate 16, 216 to allow the charged analyte of interest 42, 242 within the sample more time to concentrate into a band.

Once the sample is added, the electrode assembly 59, 259 of the stacking device 10, 210 and the first voltage source 70 is turned on. At this point, the stacking device 10, 210 is set up to concentrate, desalt, and ionize the sample toward the mass spectrometer 38 automatically without intervention from a user. The base 14, 214 and the cartridge 12, 212 can be adjusted to optimize the distance and angle of the ionized sample directed toward the mass spectrometer 38. Additionally, the parameters of the electrode assembly 59, 259 may be adjusted to control the flow of the BGE solution and the EP velocity of the charged analyte of interest 42, 242, which may impact the ability to concentrate the sample and optimize the ionization of the sample.

### EXAMPLES

### Example 1: Materials and Chemicals

All solvents, acid and base modifiers, buffers, and platinum wire were purchased from Fisher Scientific (Pittsburgh, PA, USA). Analytical drug standards and corresponding stable isotope labeled internal standards (SIL ISTDs) were purchased from Cerilliant (Round Rock, TX, USA). Polyethyleneimine, n-Octyl-beta-D-glucopyranoside, Methylene Blue, and Polyvinylpyrrolidone were purchased from Alfa Aesar (Haverhill, MA, USA). Hydroxyethyl Cellulose, 3-Aminopropyltrioxysilane, Trimethyl[3-(trimethoxysilane) ammonium Chloride, and Brilliant Blue FCF were purchased from TCI America (Portland, OR). Trimethoxysilylpropyl modified polyethylenimine, (Styrylmethyl)bis(triethoxysilylpropyl) ammonium chloride, and N,N′-Bis(3-(trimethoxysilyl) propyl)ethylenediamine were purchased from Gelest (Morrisville, PA). Whatman 1 and GF/B filters were purchased from Cytiva (Marlborough, MA). AP40 glass fiber filters and Angiotensin II (human) standard were purchased from Millipore Sigma (Burlington, MA).

An LCS150 AC/DC converter and RECOM REM5E DC/DC converter (8 kV isolation) were purchased from Mouser (Mansfield, TX). DEVMO DC-DC step-up boosters were purchased on Amazon.

### Example 2: Sample Preparation

A stock solution containing methamphetamine, cocaine, fentanyl, and morphine was prepared from analytical standards at 1.0 μg mL⁻¹ in methanol. Methamphetamine-D5, cocaine-D3, fentanyl-D5, and morphine-D6 methanol were prepared separately at 1.0 μg mL⁻¹ in methanol. Calibration standards of the drugs were prepared by parallel dilution of the stock solution to 10, 20, 50, 100, 250, and 500 pg mL⁻¹ in 50:50 MeOH:H₂O with 0.1% acetic acid. Internal standards (ISTD) were added to each calibrator at 50 μg mL⁻¹. Angiotensin II was prepared in water at 1.0 μg mL⁻¹. Stock buffer solutions were prepared at 1M in water from crystalline salts. PFOA, PFOS, PFOA 8-C13, and PFOS 8-C13 were prepared separately at 0.8 μg mL⁻¹ in 95:5 MeOH:H₂O. PFAS calibration standards were prepared by first diluting the PFAS stock solution into three solutions at 0.08, 0.8, and 8 ng mL⁻¹. These solutions were then used to spike PFAS into 5 mL of tap water drawn from the lab sink at concentrations of 1, 5, 10, 25, 100, and 250 μg mL⁻¹. Methanol, ISTDs, and ammonia were added to the tap water to form working standards containing 50:50 MeOH:H₂O with 0.1% NH₄OH. Duplicate sample solutions for both sets of analytes were prepared and spiked with organic dyes at 10 ng mL⁻¹. Methylene blue and rhodamine 6G were added to the cationic analytes and brilliant blue FCF was added to the anionic analytes.

### Example 3: Paper Modification

Polyelectrolyte Absorption: Cellulose and glass fiber membranes (i.e., the substrates 16, 28, 44, 46, 216, 228, 244, 246) were submerged in 2% polyethyleneimine (PEI) solution for one hour then rinsed with DI water three times. The membranes were allowed to dry for 2 hours at room temperature before use.

Silane Coupling Reagents: Whatman 1, GF/B, and Millipore AP40 membranes were sonicated in methanol for 30 min before silane treatment. Silane coupling reagents were prepared at 0.1% (v/v) in 85:15 ethanol:water with 0.01% acetic acid and allowed to hydrolyze for 10 minutes. The membranes were then submerged in the reaction solvent for one hour with frequent stirring. Following the reaction, the membranes were washed with ethanol and placed in a vacuum oven at 50° C. for two hours, then baked in an oven at 110° C. for one hour. Alternatively, the reaction solvent was evacuated without heating in a vacuum chamber overnight. Modified membranes were sonicated in 50:50 methanol:water for 45 minutes and dried at room temperature before use. Several combinations of silane reagents were prepared to assess the resulting changes to the substrate surface (ζ)-potential, hydrophobic characteristics, hydrolytic stability, and PS-MS performance. Various reaction solvents, silane concentrations, and reaction times were also assessed.

### Example 4: Paper Spray MS

Substrates 16, 28, 44, 46 were hand cut into rectangles of set dimensions using a razor blade and placed securely in their designated positions inside the cartridge 12 (FIGS. 2A-C). A series of consecutive cuts were made to produce the spray tip 26 in the porous substrate 16. The porous substrate 16 was then inserted in a detachable segment of the cartridge 12 and carefully re-attached such that the lower surface 48 of the spray tip 26 of the porous substrate 16 contacted the corner 34 of the voltage source connection substrate 28 (FIG. 2B).

As shown in FIG. 2A, the four interconnected substrates 16, 28, 44, 46 form a continuous fluid channel between two reservoirs 30, 40. The porous substrate 16 protrudes slightly in front of the voltage source connection substrate 28. The reservoirs 30, 40 are designed to stick out sideways beyond the cartridge 12 to streamline solvent loading.

A custom-built high precision XYZ stage was used to situate the cartridge 12 in front of the inlet 36 of the mass spectrometer 38. The spray tip 26 was positioned 4 mm away from the inlet 36 and lowered 1 mm. Spray voltage was applied to the paper channel via the connection reservoir 40 immediately after the initiation of the stacking procedure. A +6 kV and −5 kV potential was applied in positive and negative mode respectively.

Regular PS-MS was performed using preassembled plastic cartridges 12 with the spray tips 26 held 7 mm from the inlet 36. For sample solutions composed of pure solvents, 90 μl was deposited at the rear of the porous substrate 16 and a 4 KV potential was applied for one minute. Tap water samples could not be analyzed directly by regular mode PSI due to severe corona discharge. A 10 μl aliquot of tap water samples was spotted on the porous substrate 16 and allowed to completely dry at room temperature. The porous substrate 16 was then rewetted with a spray solvent of 98:2 MeOH:CCl4 with 0.1% NH₄OH prior to PS-MS analysis.

### Example 5: Power Source

A schematic of an exemplary device circuit is shown in FIG. 3. Separate power sources were used for PSI and sample stacking. The driving potential for the stacking procedure was generated by two DC/DC step-up boosters connected to a 24V AC/DC converter. High voltage isolation transformers protected the external power source from the ionization voltage provided by the MS power source.

FIG. 3 shows reservoirs 30, 40 and substrates 16, 28, 44, 46 are treated as resistors connected in series. The air gap between the spray tip 26 and the inlet 36 of the mass spectrometer 38 is also treated as a resistor, although this is a simplified representation.

The effective PSI voltage at the spray tip 26 was a function of the input of both power sources. For both positive and negative ionization mode, the voltage difference across the reservoir was unfavorable for PSI as it generated slightly higher potential between the voltage source connection substrate 28 and the inlet 36 of the mass spectrometer 38 than that of the porous substrate 16. Addition of a 10-GΩ resistor to the PSI circuit allowed the spray tip 26 of the porous substrate 16 to be positioned close to the inlet 36 of the mass spectrometer 38 without triggering electrical discharge. The resistor suppresses discharge events by maintaining a constant current in the PSI circuit. This component was only utilized for positive ionization mode.

### Example 6: Instrumentation and Data Processing

Analysis was carried out using a Thermo Scientific Q-Exactive mass spectrometer in parallel reaction monitoring mode (PRM). The instrument parameters were a tube lens voltage of 55 V, maximum injection time of 100 ms, AGC target of 5E4, a resolution of 30 000 FWHM, and a capillary temperature of 320° C. Raw data was extracted from Xcalibur (Thermo Scientific™) and integrated manually. Calibration curves were constructed with signal normalized by ISTDs and the limits of detection were defined as 3.3 times the standard error of the intercept divided by the slope.

### Example 7: 3D Printing and Design Considerations

The 3D print parameters for the uPAD-PS cartridge 12 and the base 14 are shown in Table 1. Polypropylene filament was used for all components for its chemical inertness. Platinum electrodes and additional wiring were added to the cartridge 12 after printing was completed. The cartridge 12 for the porous substrate 16 was printed separately from the liquid reservoirs 30, 40 to facilitate accurate positioning. An open design for the cartridge 12 was favored as it allowed for direct observation of the stacking process. The open design allows for a user to see the analyte of interest move along the porous substrate 16.

TABLE 1
3D Print Parameters

| | |
|---|---|
| Printer | Prusa Mini |
| Filament | Fiberology Polypropylene 1.75 mm |
| Print bed adhesion | Ultimaker 2 Adhesion Sheets |
| Layer height | About 0.08 mm |
| Line width | About 0.25 mm |
| Wall line count | 4 |
| Infill Density | About 25% |
| Print speed | About 20 mm/s |
| Fan speed | About 50% to 100% |
| Print bed temperature | Not heated |

### Example 8: Device Assembly

FIG. 1A depicts the general layout of the stacking device 10 for stacking and elution of positively charged analytes 42. Two solvent reservoirs 30, 40 formed the ends of a fluidic channel composed of four interconnected substrates 16, 28, 44, 46. The flow substrate 44 was a silanized Whatman 1 cellulose membrane. Substrates 16, 28, 46 were silanized AP40 glass fiber membranes. Bipodal amino-containing silanizing reagents were used to impart a positive Z-potential for cationic analytes. A high conductivity BGE consisting of 80 mM ammonium acetate in 25:74:1 ACN:H₂O:CH₃COOH was deposited into the BGE reservoir 30, and sample solution consisting of 25:75:0.1 ACN:H₂O:CH₃COOH was deposited into the connection reservoir 40. The fluidic channel composed of four interconnected substrates 16, 28, 44, 46 was wetted with the sample solvent or the sample solution (same solution as that in the second reservoir 40). Application of 260V between the reservoirs 30, 40 initiated EOF toward the connection reservoir 40 and electrophoretic migration of cations in the connection reservoir 40 toward the BGE reservoir 30.

FIG. 1A shows a representation of two silanized glass fiber membranes 16, 28 utilized in positive mode stacking. The electric field strength rose sharply in both the titration zone and the geometric constriction at the spray tip 26. Cations from the connection reservoir 40 moved onto the porous substrate 16 and stacked in via FASS. FIG. 1B shows the sample band was then transported with the EOF towards the spray tip 26 while undergoing further concentration. FIG. 1C shows cations moving through the spray tip 26 were ionized and entered the inlet 36 of the mass spectrometer 38.

Several materials were investigated for use as stacking mediums including cellulose, glass fiber, polyvinylidene fluoride (PVDF), nylon, porous polyethylene and polytetrafluoroethylene (PTFE), silica, and nitrocellulose. Over 30 different membranes were tested overall, and sample stacking could be accomplished in almost all these with the appropriate solvent selection. Glass fiber was selected as the primary substrate material because it had high solvent capacity and could be derivatized easily. Only two glass fiber filter papers were technically required to construct the paper fluidic channel; the porous substrate 16 could be bent into the BGE reservoir 30, and the voltage source connection substrate 28 could be inserted directly into the connection reservoir 40. However, assembling the paper channel was easier without bending substrates 16, 28, and the additional filter papers 44, 46 provided functional flexibility. Inclusion of the flow substrate 44 provided a means of suppressing EOF on the porous substrate 16. Inclusion of the connector substrate 46 allowed for a shorter distance between the spray tip 26 and the connection reservoir 40 by decreasing the wetting of the voltage source connection substrate 28 through capillary action. Capillary wetting would ideally have been absent from the stacking device 10 as it represented a non-essential variable that had opposite effects on the flow rate at opposing ends of the fluidic channel.

The junction of the porous substrate 16 and the voltage source connection substrate 28 may affect both ionization and stacking. The positioning of the two substrates 16, 28 determines the flow rate through the stacking device 10 and the shape of the adjacent field gradient. A detachable cartridge 12 for housing the porous substrate 16 was printed to aid in the alignment and linking of the two substrates 16, 28. The presence of the substrate 16, 28 junction meant that the voltage source connection substrate 28 inevitably contributed to the electric field between the spray tip 26 and inlet 36 of the mass spectrometer 38. The half-pyramidal shape of the spray tip 26 shown in FIG. 2B allows the spray tip 26 of the porous substrate 16 to be closer to the inlet 36 than the voltage source connection substrate 28 while still maintaining the requisite connection between the two substrates 16, 28. The most stable spray signal was achieved when the spray tip 26 was slightly below the inlet 36, likely a result of less electric field contribution from the voltage source connection substrate 28 in this configuration. A spray tip 26 that is clean (i.e., free of protruding fibers) is useful to focus the electric field on the spray tip 26. The importance of clean and precise cutting has been well documented with paper spray. Furthermore, due to the electrokinetic processes occurring on the porous substrate 16, frayed edges tend to accumulate large liquid droplets that obstruct regular spray.

### Example 9: Stacking and Ionization Mechanism

The stacking and ionization procedure for positively charged analytes 42 was initiated by wetting the porous substrate 16 with the low conductivity solution and applying a potential of 260 V between the connection reservoir 40 (+, anode) and the BGE reservoir 30. The stacking device 10 was simultaneously floated at a high voltage (+4.5 kV typically). For cationic analytes and glass fiber filter papers with a positive ζ-potential, electrophoretic migration of cations in the connection reservoir 40 (including the analytes 42) toward the BGE reservoir 30 began immediately. EOF occurred from the BGE reservoir 30 toward the connection reservoir 40, but was initially low because of the lack of an electric double layer due to the low ionic strength of the solution wetting the porous substrate 16. Stacking of cationic analytes 42 occurred initially at the boundary between the high conductivity BGE from the BGE reservoir 30 and the low conductivity sample solution from the connection reservoir 40. This low conductivity zone was enhanced by the titration of acetate ions electromigrating from the BGE reservoir 30 with the H⁺ ions moving in the opposite direction from the connection reservoir 40. An abundance of H⁺ was present in the connection reservoir 40 solvent from both the addition of acetic acid and electrolysis of water at the anode (the second reservoir 40). Continuous titration of the BGE reservoir 30 BGE as it saturated the porous substrate 16 resulted in a narrow leading zone of low conductivity and a steep electric field gradient. Positively charged analytes 42 that were electromigrating through the porous fiber networks in the filter membranes experienced abrupt deceleration as the analytes 42 encountered field gradients and concentrated into narrow bands due to rapid influx of additional analytes molecules. The stacking process is called field amplified sample stacking (FASS) and has been implemented in CE and paper-based analytical devices.

The low conductivity solution on the porous substrate 16 was replaced by the BGE from the BGE reservoir 30 due to a combination of evaporation and EOF from the BGE reservoir 30. The EOF increased as a result, exceeding the EP velocity of the analytes 42 and pushing the stacked band towards the spray tip 26 where ionization occurs. The stacked analyte bands 42 slowed down and were further concentrated as the bands 42 moved toward the spray tip 26, suggesting nonlinear changes in the analyte electrokinetics. These changes arose due to an increase in the electric field from geometric constriction, similar to what has been reported for some microchannels and paper-based analytical devices. The higher electric field was caused by a combination of the tapering first substrate 16 and the narrow fluid channel connecting the porous substrate 16 and the voltage source connection substrate 28. The narrowing and slowing of the band 42 suggests nonlinear changes in the analyte electrokinetics. Analyte bands 42 ionized as the bands 42 traverse the region of Tayor cone formation above the substrate 16, 28 junction (FIG. 1C). The stacked band 42 slows and becomes more concentrated as it nears the substrate 16, 28 junction.

In addition to the lower electrophoretic potentials, the stacking device 10 was simultaneously floated at high potential relative to the inlet 36 of the mass spectrometer 38 to generate electrospray. Analyte bands 42 were ionized as the bands 42 traversed the region of Taylor cone formation above the substrate 16, 28 junction (FIG. 1C). The MS signal was significantly amplified in comparison to the unstacked sample.

### Example 10: Substrate Modification

Effective absorption of PEI onto the glass fibers successfully switched the direction of EOF as confirmed by stacking positively charged methylene blue and rhodamine 6G. PEI absorption proved unsuitable for the MS-coupled method, however, because of significant leeching into the MS spray solvent and heavy interference. Covalent bonding via trimethoxysilylpropyl modified PEI greatly reduced the interference but did not fully eliminate it. Hydrolysis of the silane-substrate oxane bond was an inevitable consequence of using aqueous spray solvents.

Trimethyl[3-(trimethoxysilane) ammonium chloride and 3-Aminopropyltrioxysilane were also tested. Levels of interference produced by these reagents without stacking was relatively low, but the interference became prohibitive following EK stacking because the hydrolyzed aminosilanes were stacked and eluted similarly to analyte ions. The dipodal silanes (Styrylmethyl)bis(triethoxysilylpropyl) ammonium chloride and N,N′-Bis(3-(trimethoxysilyl) propyl)ethylenediamine were found to completely resolve the interference problem. These reagents contain six bonding sites rather than three and are estimated to form a substrate bond 10,000 times more resistant to hydrolysis. Glass fiber membranes modified with dipodal silanes rarely produced interference distinguishable from the typical background during stacking. The silane structure, reaction concentration, and reaction time were the parameters that influenced the behavior of the modified membranes. Reproducible adjustment of the membrane z-potential and control EOF velocity was achieved by methodically adjusting the reaction conditions until the desired results were observed during stacking procedures. Although the target Z-potential may be reliably imparted, manipulation of the EOF through controlling the Z-potential may be impractical due to the necessity of repeating time-consuming reaction optimizations for different EOF magnitudes. An altogether different approach to controlling EOF was therefore developed, and a general substrate modification procedure was established. In this general procedure, emphasis was placed on imparting moderate hydrophobicity to the membranes. This was a useful consideration because a substrate with surface energy similar to the surface tension of the spray solvent produces a smaller Taylor cone and higher ionization efficiency. The optimized reaction conditions produced spray substrates that were wettable with aqueous solvents containing ≥10% methanol but not below, thus coordinating the surface energy with the use of high water content solvents.

For negative mode analysis, EOF may need to be slightly suppressed because the ζ-potential of glass fiber membranes was too high.

### Example 11: BGE Selection

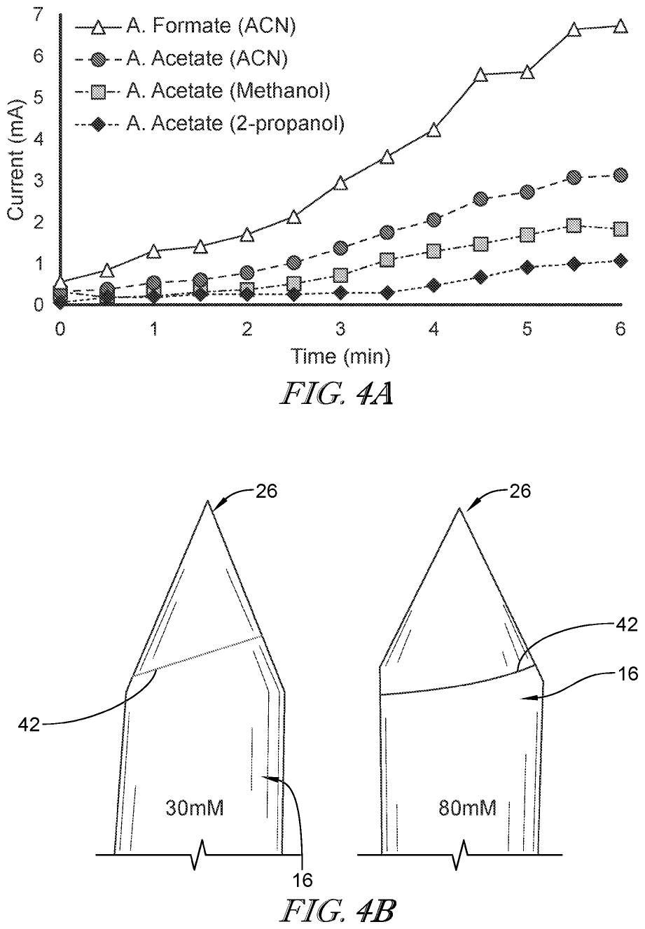

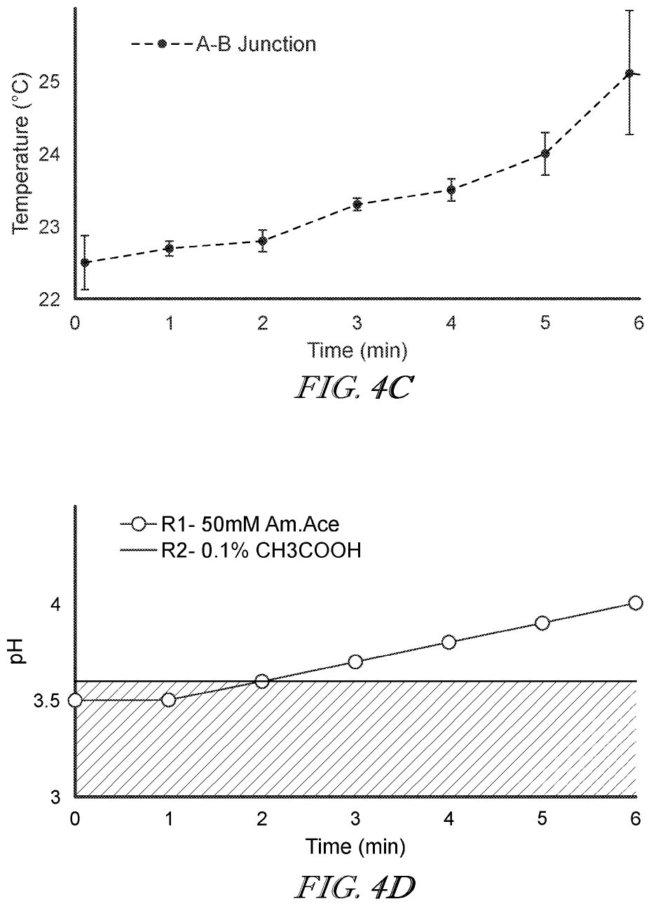

Unlike existing paper-based EK stacking methods, the stacking device 10 was coupled directly with the mass spectrometer 38 via the spray tip 26. To ensure MS compatibility, a portion of the BGE solvent may be organic, and MS compatible salts and acids like ammonium acetate and acetic acid may be used. The organic solvents investigated had a direct and significant effect on both EOF and analyte electrophoretic mobility. The exception was acetonitrile, which increased electrical resistance much less than other solvents like methanol, ethanol, trifluoroethanol and isopropanol (FIGS. 4A and 4B). Addition of acetonitrile to aqueous BGEs did not diminish the quality of EK stacking to the same extent as other organic solvents and was therefore selected as the co-solvent for cationic analytes. Methanol was selected for stacking anionic analytes because it produced a more stable MS signal than acetonitrile in negative ionization mode. The quality of the stacking procedure inevitably decreased with increased organic concentration, while the opposite was generally true for ionization efficiency. A balance therefore had to be established between stacking efficiency and ionization efficiency. Organic concentrations in the paper channel and the first reservoir 30 between 20-35% provided the best compromise. The electrolyte in the reservoir 30 served two main functions; first, it established the prerequisite conductivity differentials on the paper channel to allow for FASS (FIG. 4B). Second, it maintained pH levels to keep the target analytes ionized as water electrolysis produced H⁺ or OH⁻ ions in the reservoir 30, depending on the stacking polarity (FIG. 4D). In positive ionization mode, ammonium acetate/acetic acid BGEs were selected over ammonium formate/formic acid. The lower conductivity of the acetate-based BGEs reduced electrical current and therefore joule heating effects. The acetate ion caused notable interference in negative ionization mode, however, and was replaced with ammonium bicarbonate for analysis of anionic analytes. Solvent composition in the reservoir 40 did not have to match the solvent composition in the rest of the paper channel.

FIG. 4A is a graph showing current verses time of the stacking device 10 operated under 250 V in positive mode. The BGE concentration was 80 mM. A steady increase in current is observed as the high conductivity BGE entered the paper channel from the reservoir 30. The current plateaued when the entire channel was saturated with the BGE. FIG. 4B shows FASS stacking of the cationic dye methylene blue in 75:25 H₂O:ACN on silanized glass fiber. Little to no FASS stacking was observed with BGEs below 30 mM. The sample bands were present but often diffuse at concentrations between 30-50 mM. BGE concentrations greater than or equal to 50 mM produced narrow sample bands. FIG. 4C is a graph showing temperature measured by laser temperature gun near the spray tip 26 of the porous substrate 16. FIG. 4D shows a graph of pH change in both reservoirs 30, 40 during the stacking procedure. The pH in the reservoir 40 changed in a favorable direction from its initial value of about 3.6.

### Example 12: Controlling EOF

EOF played a useful role in the pre-concentration procedure. The stacking device 10 may use EOF velocity slightly higher than the electrophoretic velocity of the target analytes and in the opposite direction. Cellulose and glass fibers membranes have negative surface charge due to an abundance of hydroxyl groups, making them suitable for EK stacking of negatively charged analytes. Cationic analytes require a positive surface charge to stack efficiently, which may be accomplished using amino-containing silanizing reagents. Failure to produce adequately large Z-potential may lead to diffused stacking bands and analytes transported in the wrong direction away from the ionization zone. Excessive Z-potential introduced visible turbulence and instability in the stacking bands. Silane over-application also risked producing an EOF strong enough to flood and stall the stacking device 10 because the maximum flow rate was not homogeneous across the fluid channel. Viscosity modifiers, commonly used in paper-based and traditional microfluidic devices, were not compatible with MS ionization due to significant interference and ion suppression.

To enable adequate and straight-forward control of EOF without producing a range of different modified papers, additional means of tuning the EOF while maintaining simplicity, easy fabrication, and low material cost may be advantageous. EOF was reduced by limiting solvent transfer onto the stacking device 10 by connecting the BGE reservoir 30 to the porous substrate 16 with a low flow rate filter paper (i.e., the flow substrate 44). When the flow substrate 44 with low flow rate was connected to the porous substrate 16 with a high flow rate, the total flow rate was limited by the low flow rate flow substrate 44. Under the condition of active EOF, a low flow rate flow 44 prevented full saturation of a high flow rate porous 16. This could be ascribed to the porous substrate 16 transferring solvent to the voltage source connection substrate 28 faster than the porous substrate 16 could receive solvent from the flow substrate 44. The practical consequence of insufficient solvent flowing from the flow substrate 44 to the porous substrate 16 was that the default flow rate on the porous substrate 16 and between the porous substrate 16 and the flow substrate 44 could not be sustained. The relative force exerted by the EOF and EP was therefore subject to adjustment by appropriately pairing different filter papers. When a solvent constraining condition was successfully established, depositing a few microliters of solvent at the rear of the porous substrate 16 would immediately cause the stacking band to accelerate towards the spray tip 26 for a brief amount of time. The distance the band moved was proportional to the volume that was deposited. Because this method relied on creating an imbalance in the system, there was a limit to how much EOF could be suppressed before an apparent EOF gradient emerged across the channel. In this case, the flow at the front end of the channel was insufficient to elute the sample band and no MS signal was generated. This limit became relevant when it was desirable to have a slow-moving sample band to maximize the amount of sample in the connection reservoir 40 that entered the first substrate 16 before elution.

### Example 13: Device Performance

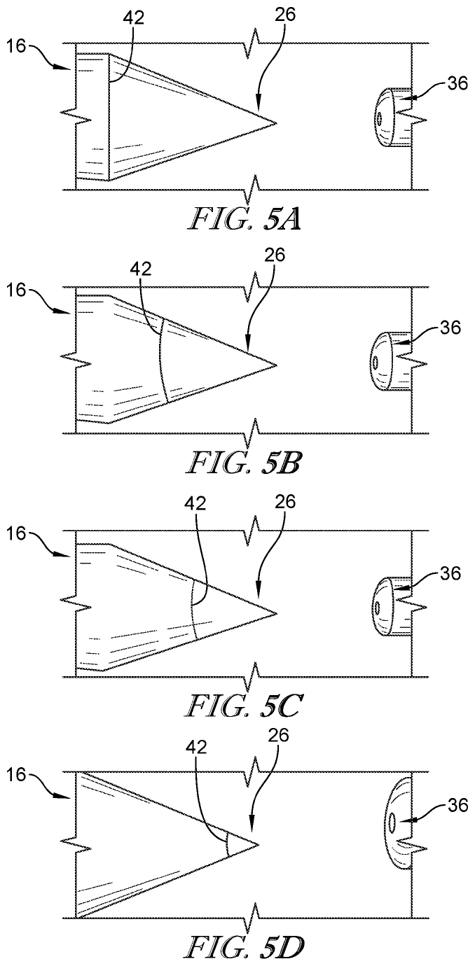

The parameters that influenced the performance of the stacking device 10 were applied voltage, current, channel dimensions, and BGE composition. The relationships between these parameters were such that no one variable could be adjusted much by itself without causing an imbalance in the procedure. A series of trade-offs was required as adjustments that were beneficial to the stacking process were often detrimental to the MS analysis. FIGS. 5A-5D shows the progression of EK-pre-concentration of methylene blue coupled on-line with PSI.

FIG. 5A shows methylene blue molecules stacked via conductivity-FASS in the central region of the porous substrate 16. FIG. 5B shows a strong EOF in the direction of the spray tip 26 transported the sample band 42 towards the inlet 36 of the mass spectrometer 38. FIGS. 5C and 5D shows the sample band 42 slowed and concentrated further as it moved into the spray tip 26 due to geometric-FASS. The constriction in the paper channel also contributed an additional concentration factor by compressing the sample band 42 horizontally.

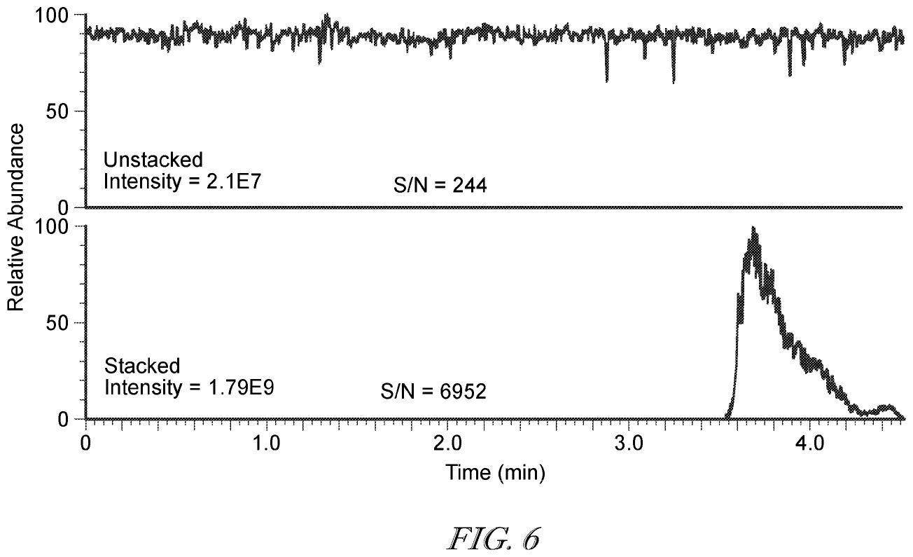

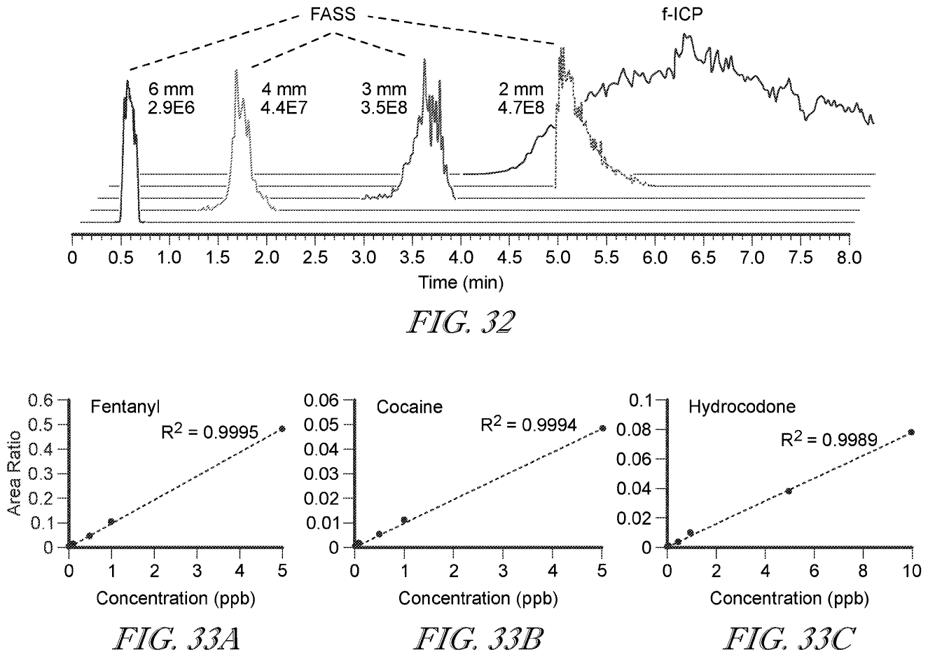

The chronograms from electro kinetic stacking-paper spray-mass spectrometry (EKS-PS-MS) procedures were distinctly different from regular PS-MS as seen in FIGS. 6 and 32. No analyte signal was observed for up to several minutes, then the signal spiked for a brief period before disappearing again. The signal amplification derived from the stacking procedure was the result of harnessing a large portion of the total regular-PSI signal in a short time window. It is useful to note that the signal peaks did not necessarily represent the elution of the entire mass of the sample, but rather the concentration of the band that traversed the spray tip 26 of the porous substrate 16. When a high concentration of organic dyes was analyzed, the sample band 42 could be observed moving into the voltage source connection substrate 28 after crossing the spray tip 26. Peak shapes were a good indicator for the success of a stacking procedure, although peak shapes may vary based on other factors, such as the EOF velocity and quality of the paper cutting. A narrower chronogram peak normally correlated with higher signal intensity, but could have also resulted from a fast-moving sample band 42. Conversely, wide peaks were typically indicative of poor EK-stacking and generated lower signal but could also have represented a very slow-moving sample band 42. The relationship between peak width, EOF velocity, and elution time is displayed in FIG. 32. The EOF velocity was not directly measured but was related to the width of the flow substrate 44.

FIG. 6 shows a regular PS-MS generated analyte signal from voltage onset until the spray solvent depletes or the voltage is turned off. EK-PS-MS did not generate signal for target analytes until the sample band 42 reached the spray tip 26 of the porous substrate 16. During the stacking procedure, there was constant MS-signal from background ions that were not participating in the EK-process. FIG. 32 shows the width of the flow substrate 44 governed the volume of solvent entering the porous substrate 16 and controlled EOF. All other device parameters were held constant while the width of the flow substrate 44 was adjusted to increase or decrease elution time.

In f-ICP, stacking occurs on the voltage source connection substrate 228 with subsequent slow migration of the sample band 242 onto the spray tip 226 of the porous substrate 216 for ionization. Band migration occurs due to the increasing size of the IDZ 231. Balancing of the EOF/EP is therefore not a necessity for band migration in f-ICP. Nevertheless, the opposing forces help maintain narrow bands. Compared to FASS, f-ICP electropherograms show broader peaks due to slower movement of the band 242 through the ionization zone 231, as shown in FIG. 32. The stacked analyte band 242 itself is not visually broader in f-ICP compared to FASS.

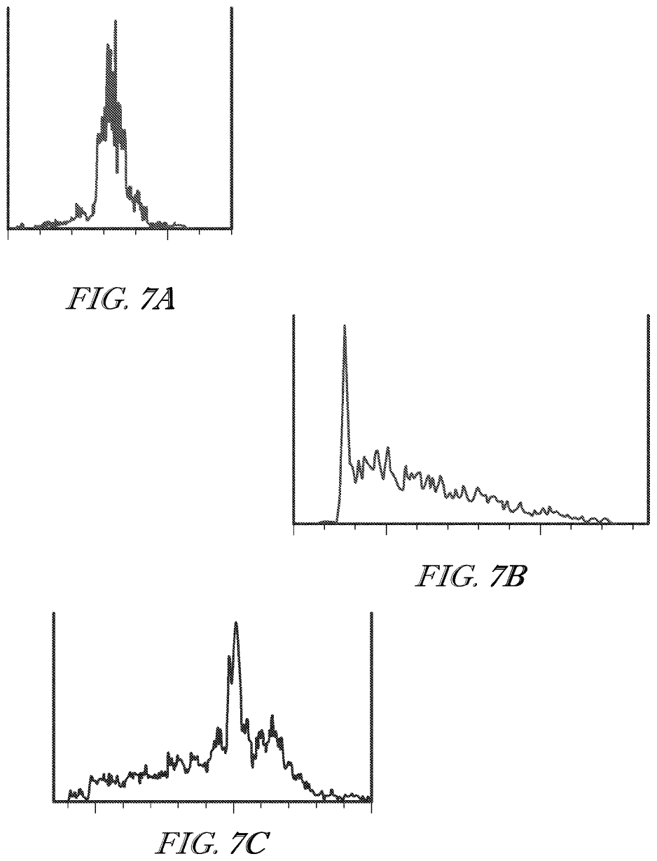

Cationic and anionic dyes were useful for direct observation of the sample stacking, but when these dyes were pre-concentrated to levels that were easily visible to the naked eye, the extreme particle density introduced space-charge effects. These effects warranted further examination because they could conceivably be generated by any compound present in excess concentration during the stacking process. Above a certain concentration threshold, one of two different phenomena was observed as the sample band 42 moved into the spray tip 26 depending on its velocity. A fast-moving band 42 moved into the spray tip 26 and experienced a strong repulsive force that caused it to rapidly bounce backwards and disperse. A slow-moving band 42 decelerated almost to a halt and began to widen before moving through the spray tip 26. Other analytes present in the sample band 42 also experienced these effects and yielded distinctive chronograms as a result (see FIGS. 7A, 7B, and 7C).

FIG. 7A shows characteristic peak shape of a sample moving through the spray tip 26 undisturbed by space-charge effects. FIG. 7B shows characteristic peak shape of a sample band with high charge density moving quickly into the spray tip 26 before being repelled and dispersed. FIG. 7C shows a peak shape indicative of dispersion prior to elution due to excessive charge density.

Sample solutions could be deposited directly on top of the porous substrate 16 or dissolved in the connection reservoir 40. When spotted on the porous substrate 16, the sample volume was limited to about 80 μL due simply to the physical size of porous substrate 16 and could be completely stacked in about one minute. Shorter times may lead to poor stacking performance owing to turbulent flow at very high EOF. To minimize the risk of poor stacking, a target elution time between one and two minutes minimized failures due to excessive EOF.

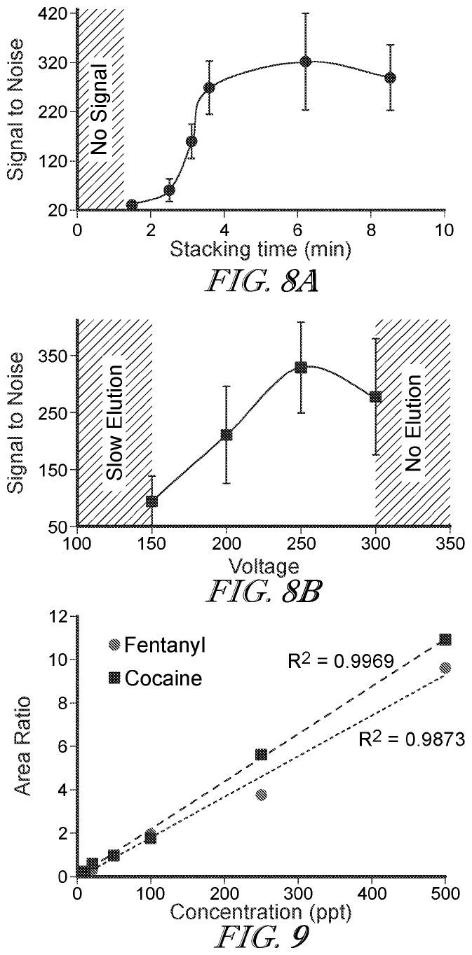

Sample solutions deposited into the connection reservoir 40 produced higher signal with time (see FIG. 8A). When the electric field was imposed on the paper channel, there was a brief initial period where EOF was higher than EP until the constrained solvent flow could take effect. At this point, there was a time window in which the analytes could migrate onto the porous substrate 16 before the high conductivity BGE reached the spray tip 26. After the BGE saturated the first substrate 16, analytes still dissolved in the connection reservoir 40 could not contribute to MS signal because their electrophoretic velocity was insufficient to overcome the EOF. For sample volumes between 150-600 μl, stacking/elution times between four and six minutes produced the best results.

FIG. 8A shows a 200 μl solution of fentanyl at 0.1 ng mL⁻¹ (deposited in the second reservoir 40) analyzed with varying elution times. Significantly higher signal was generated with elution times above three minutes while little was gained by sustaining the pre-concentration above six minutes. FIG. 8B shows a 200 μl solution of Angiotensin II at 1.0 ng mL⁻¹ analyzed under different applied voltages.

Higher EK voltages produced narrower sample bands when stacking dyes. However, the asymmetric distribution of the electric field across the paper channel began to manifest disproportionate effects on analytes with different mobilities above 300V. Low mobility analytes such as Angiotensin II and Rhodamine 6G could, for example, fail to move from the connection reservoir 40 through the substrate 16, 28 junction into the porous substrate 16. On the opposite side of the junction, the higher mobility methylene blue could get stuck on the first substrate 16 before reaching the spray tip 26. At higher EK voltages, the system could not be optimized for both sets of compounds; only the analytes with fast or slow electrophoretic mobilities could be analyzed successfully. The most consistent results were achieved for a wide-range analyte mobilities with voltages in the range of 200-300V. The general method adopted 260V as the default potential to accommodate all cationic analytes. The PFAS method was not developed for general applicability however, and a larger potential was applied because these compounds had very similar mobilities. In this case, the voltage was limited by operating currents.

The detection capabilities for cocaine, morphine, fentanyl, angiotensin II, PFOA, and PFOS were improved significantly through coupling with EK-Stacking as seen in Table 2. The method was most effective for the relatively hydrophilic compounds morphine and angiotensin II. This could be because the unfavorable retention that hydrophilic compounds experience on the paper substrate are reduced when they are transported via electrokinetic effects. The reason why cocaine appeared to have responded relatively poorly to the stacking procedure is unknown. Detection capacity for the peptide No ISTD for Angiotensin II was available during testing, so the limit of detection (LOD) was estimated based on the presence of the characteristic [M+2H]²⁺ peak at m/z 523.77 at a S:N ratio above 10.

TABLE 2
LODs for Selected Analytes

| | | |
|---|---|---|
| Cocaine | 7.2 ppt | 80 μl Positive mode |
| Fentanyl | 3.9 ppt | |
| Morphine | 9.5 ppt | |
| Angiotensin II | 100 ppt | |
| PFOS | 0.288 ppt | 500 μl Negative mode |
| PFOA | 0.723 ppt | |

Turning to FIG. 9, FIG. 9 is a graph showing calibration curves for fentanyl, cocaine, and morphine stacked from 80 μl of sample solution. The greatest detection capacity improvement was seen for morphine which can typically not be detected below 1.0 ppb using regular paper spray.

### Example 14: Negative Mode: PFAS Screening of Tap Water

Sample stacking in negative mode was carried out by reversing the polarity of the stacking device 10 and utilizing substrates 16, 28, 44, 46 with negative surface charge. The high conductivity BGE consisted of 50 mM ammonium bicarbonate in 25:74:1 MeOH:H₂O:NH₄OH, and the paper channel was wetted with 50:50 MeOH:H₂O 0.1% NH₄OH. Due to the relatively high conductivity of the tap water, it was diluted 1:1 with methanol 0.2% NH₄OH before adding it to the BGE reservoir 40. Upon dilution with methanol/ammonium hydroxide, calcium carbonate precipitated from the tap water; Indianapolis has some of the hardest water in the US. Inclusion of the calcium carbonate precipitate when transferring sample solution to the stacking cartridge did not affect the device performance.

A 420V potential was applied to initiate stacking of tap water solutions. It was possible to further increase the potential and reduce the analysis time by several minutes, but joule heating effects became pronounced above 450V. At greater than or equal to 500V, the current would occasionally increase without plateauing and result in the spray tip 26 burning. This suggested a thermal run-away effect as conductivity increased with temperature. The relatively high conductivity of the sample solution caused the initial sample bands stacked at the solvent interface to diffuse. The analytes stacked more efficiently in the geometric field gradient where they remained fixed until the influx of electrolyte cations from the tap water began to decline. High electrolyte concentration, particularly in the form of divalent calcium and magnesium, was responsible for the temporary reduction in EOF.

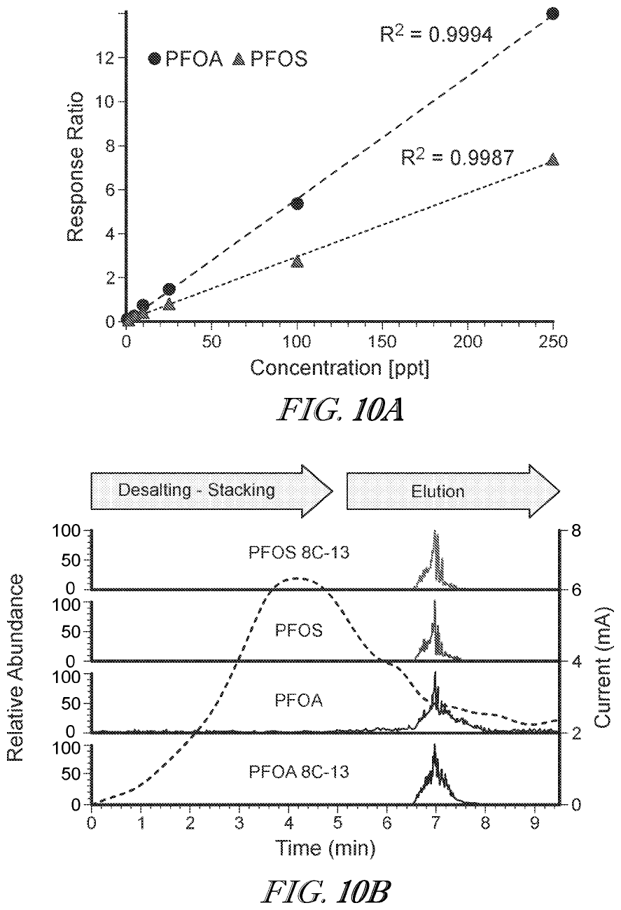

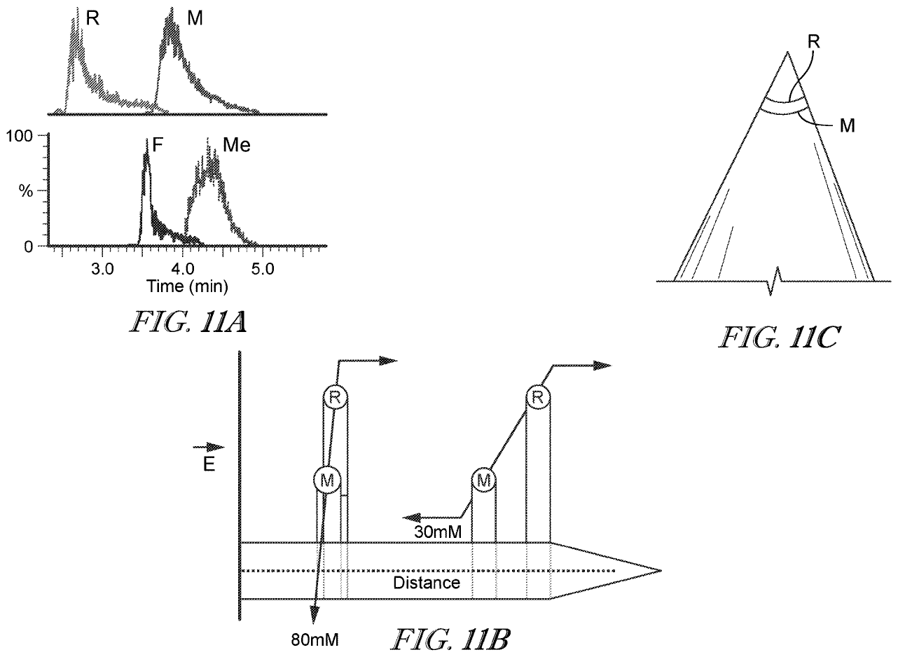

Turning to FIG. 10A, FIG. 10A shows calibration curves for PFOA and PFOS, while FIG. 10B shows MS/MS chronograms for monitored transitions with overlayed current verses time at 420V applied potential. Rapid increase in current followed by decline and gradual leveling is consistent with EK desalination. High mobility small anions from the salty tap water entered the channel and moved to the connection reservoir 30 while small cations remained in the BGE reservoir 40. Lower mobility molecules were retained in the channel by the EOF counterflow and stacked at the spray tip 26.

The 75% water BGE produced good stacking and displayed high resiliency to joule heating as expected. Remarkably, it was also a good spray solvent. When similar solutions were attempted using regular PS-MS, severe discharge was observed immediately when applying high voltage to initiate paper spray. Since no backup resistor was utilized in the PFAS cartridges and no discharge was observed, an intrinsic mechanism to suppress corona discharge arises while operating the stacking device 10. The better-than-expected ionization efficiency could possibly be ascribed to the low solvent availability at the spray tip 26 and to a lesser extent the elevated local temperature. These conditions have been shown to promote the formation of smaller PSI droplets and faster droplet evaporation. The low solvent availability was a result of the EOF continuously transporting solvent into the first substrate 16, and joule heating was the source of elevated temperatures. Calibration curves for PFOS and PFOA showed good linearity in the concentration range 1-250 pg mL⁻¹ (see FIGS. 10A and 10B). The LODs for PFOS and PFOA were 0.28 and 0.72 fg mL⁻¹. The improvement in detection capacity for these common PFAS contaminants was roughly 600-fold compared with regular PS-MS. Other PFAS compounds including PFNA, PFOSA, PFDA, PFUDA, PFDoa, PFTrDA, PFTeDA, and 6:2 FTS also produced good signal at the lowest calibration level, indicating a detection limit below 1 pg mL⁻¹. Two out of the 24 trials failed to produce adequate signal for both analyte and internal standard which was attributed to poor paper cutting.

### Example 15: Separations

Coeluting compounds can cause ion suppression. Spectral interference is another difficulty. To this end, crude separations on the filter paper were explored by widening the electric field gradient induced by the conductivity difference. The mechanism of FASS separations on μPADs has been previously described and was implemented by using a lower than optimal BGE concentration. Molecules with different electrophoretic mobilities stacked at different locations along the gradient and entered the geometric-FASS region already crudely separated. During passage through the second gradient, the separation effect could be greatly enhanced if high potentials were applied. For analyte pairs with sufficiently different mobilities, such as rhodamine 6G/methylene blue and fentanyl/methamphetamine, the process gave nearly complete separations (see FIGS. 11A and 11B). Low-mobility analytes eluted first from the stacking device 10 because of their lower EP velocity. For compounds with closer mobilities, such as cocaine and morphine, the separations were not complete, and bands had significant overlap. Near complete separations were occasionally produced by this process as seen in FIGS. 11A and 11B, but they were more commonly crude and with significant overlap. The objective of introducing separations was to alleviate the negative effects of very rapid ion influx accompanying the stacking band.

FIG. 11A shows chronograms from a mixture containing methylene blue [MB] and rhodamine 6G [R] stacked against a 35 mM BGE. FIG. 11A also shows chronograms from a mixture containing fentanyl [F] and methamphetamine [Me].

FIG. 11B shows FASS separation of methylene blue and rhodamine 6G occurs because the mobility of methylene blue is higher than rhodamine 6G, causing it to stack further down the electric field gradient. Rhodamine 6G elutes before methylene blue because the dyes are moving counter to their EP with the EOF. Reducing the steepness of the conductivity gradient promoted separation of molecules with different electrophoretic mobilities.

### Example 16: 3D Printing and Design Considerations

High overall print quality made the stacking device 10 more reliable. A small nozzle diameter, low layer heights, and slow print speeds yielded long print times but significantly increased stacking device 10 performance. The choice of filament was useful in this regard. Several different polypropylene (PP) filaments were tested during development, and the Fiberology PP filament was found to be best suited for printing the stacking device 10. Warping and layer adhesion issues that were common in all other tested PP filaments were almost completely absent in this brand. When designing a stacking device 10, there were four considerations. First, the papers should make as little contact with the stacking device 10 as possible. This may be useful near the reservoirs 30, 40 where extended contact can produce a phenomenon in which solvent is spontaneously transported up along the interface. Second, the main fluid channel (the substrates 16, 28) should be securely held in place. A separate cartridge 12 for the porous substrate 16 that can be fastened to the base 14 is a viable approach. Third, sufficient distance should exist between the top of the solvent in the reservoirs 30, 40 and the main fluid channel (the substrates 16, 28) to minimize the effects of capillary transport during stacking. Fourth, two reservoirs 30, 40 should not share the same wall. Insertion of a 0.1 mm gap between the reservoirs 30, 40 is sufficient.

### Example 17: Joule Heating

Appearance of joule heating effects coincided with sustained currents above about 4-6 mA and were observed near the substrate 16, 28 junction first. Mild manifestations were in the form of slight deviations in the expected behavior of the sample band (e.g., dispersion, deformation). These may have been triggered by changes in the temperature-dependent properties of fluid channel such as the z-potential, molecular diffusivity, electrical conductivity, and viscosity, followed by localized fluctuation in the EOF and analyte EP velocity. Another possibility is that the temperature gradient surrounding the spray tip 26 grew sufficiently steep to influence the direction of the solvent flow. Mild effects introduced a degree of variability but were deemed acceptable as they did not negatively impact analyte ionization. With sustained currents between about 6-9 mA, small bubbles gradually started appearing underneath the spray tip 26 on top of the voltage source connection substrate 28. Further increase in current beyond this point made the stacking device 10 susceptible to catastrophic failure in the form of larger bubbles that blocked the spray tip 26 and the physical decomposition of the spray tip 26. The inevitable presence of joule heating during pre-concentration meant that the applied voltage could not be arbitrarily elevated to speed up elution. Attempts were made to decrease joule heating effects by increasing the cross section of the substrate 16, 28 junction and by incorporating solvents with low dielectric constants. In both cases, there was an unfavorable trade-off in stacking device 10 performance. Surprisingly, when greater than or equal to about 75% methanol BGEs were utilized to reduce operating current, the joule heating effects became more severe. Close-up observation of the substrate 16, 28 junction showed that the increased rate of evaporation led to solvent depletion when high voltages were applied. It appeared that poor heat dissipation capacity under these conditions made the substrates 16, 28 more prone to burns. This interpretation was corroborated by the finding that BGEs with greater than or equal to 75% water operated at much higher current levels but were less susceptible to joule heating effects.

### Example 18: Interference

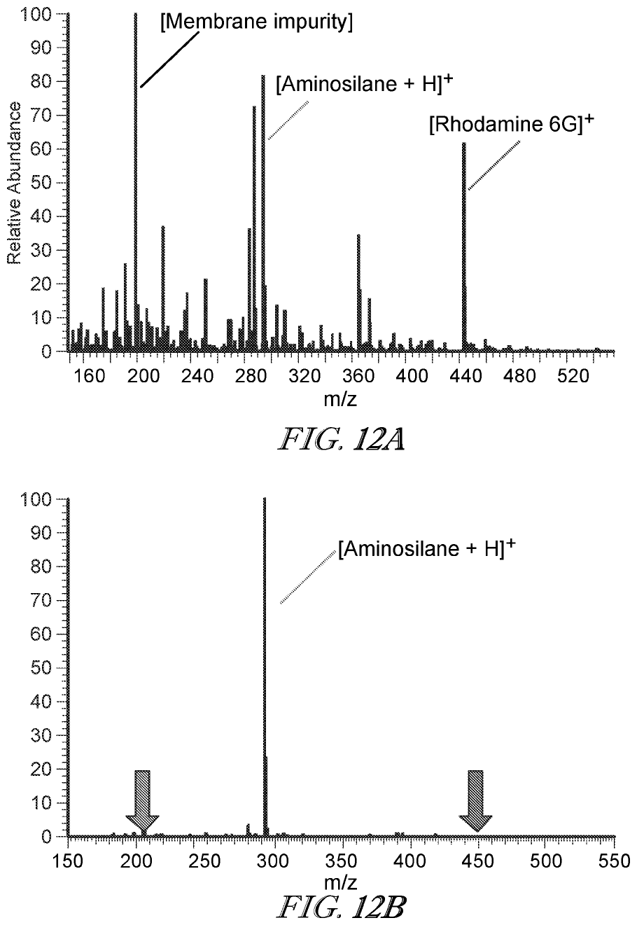

Intense background noise from membrane impurities that leech into the spray solvent is present in PS-MS. The diverse background spectra also regularly contain contaminants from external sources such as the solvents, glassware, and human contact. Some of these background peaks were amplified during pre-concentration, and their presence at high relative intensities tended to coincide with noticeable signal suppression of target analytes in positive ionization mode. The signal suppression was probably caused by the immense particle density in the stacking band saturating the surface of the electrospray ionization (ESI) droplets and/or competing for available charge. Post-interface signal suppression may also have played a role as competition for the limited space inside the C-trap prevented low abundant analytes from accumulating sufficiently. FIGS. 12A and 12B show how interference differed greatly between regular PS-MS analysis and EK-stacking PS-MS.

FIG. 12A is a graph showing regular PS-MS spectra of rhodamine 6G sprayed from an unwashed modified glass fiber membrane. Residual unreacted or hydrolyzed aminosilanes produced an intense peak at m/z 294.2 FIG. 12B shows the same solution stacked yielded almost complete suppression of rhodamine 6G as well as other background ions.

Two strategies were adopted to address the interference from contaminants. First, sonicating the silanized membranes in spray solvent partially extracted membrane impurities and reduced the relative abundance of the background ions. Second, BGE solutions were prepared fresh on a weekly basis with HPLC-grade solvents.

A different form of potential interference was observed when stacking high concentrations of organic dyes. There existed a threshold at which the visual intensity of dye bands ceased to rise with increased dye concentration, and instead the width of the bands began to increase. Because the local charge in the narrow bands was not balanced, this threshold likely corresponded with the upper charge density limit determined by the devices operating parameters. When two or more dyes contributed to the same stacking band, the widening effect applied to all dyes even when only one of them was added in excess. Overabundance of ions in the stacking band may therefore not only cause MS signal interference, but also diminish the pre-concentration effect of low concentration analytes. Both the ESI-type and the EK-type of interference were predicated on the same initial condition, so it was not possible to ascertain to what extent each type was responsible for reduced MS signal.

### Example 19: EP Elution Mode

The preceding results use EOF to push the analyte band 42 to the spray tip 26 of the porous substrate 16. The process can be reversed to use EP to push the band 42 to the spray tip 26 as illustrated in FIGS. 13A-13C. FIGS. 13A-13C show a schematic of electrophoretic elution for cationic analytes. The flow substrate 28 and the spray tip 26 of the porous substrate 16 were first wetted with a high conductivity BGE (80 mM ammonium acetate in 50:50 H₂O:MeOH with 1% acetic acid) and 50:50 H₂O:MeOH is deposited in the BGE reservoir 40. Then, a sample solution (50:50 H₂O:MeOH with 1% acetic acid) is deposited in the connection reservoir 30. At voltage onset, hydrogen ions from the sample solvent migrate towards the cathode and encounter the BGE front where they initiate neutralization reactions with the acetate ions. Continuous titration of the BGE produces a narrow boundary between the sample solution and the BGE wherein a sharp drop in conductivity gives rise to a steep electric field gradient. The BGE is also simultaneously titrated by hydroxyl ions at the opposing end due to water electrolysis in the BGE reservoir 40. Cationic analytes from the connection reservoir 30 that arrive in the zone of titration decelerate and stack into narrow bands with the influx of additional analyte molecules. As the titration proceeds, the sample/BGE boundary is slowly shifted towards the spray tip 26 with the analyte band 42. EOF flow velocity in the fluid channel is tuned to be slightly lower than the EP flow velocity of the analytes 42 to allow the analytes 42 to steadily progress towards the counter-electrode. Analytes 42 ionize when the analytes 42 traverse the spray tip 26. EP elution mode places more demanding conditions on the substrate modification procedure relative to EOF elution mode but offers several advantages. Higher potentials of up to 650V can be employed in EP mode which allows for faster pre-concentration. The operating current spikes at voltage onset but then quickly declines as the limited volume BGE is neutralized from both ends of the fluid channel. Sample bands 42 are narrower and exhibit higher cohesion as the analytes 42 move through the spray tip 26 with increased applied voltage and higher signal amplification is derived as a result.

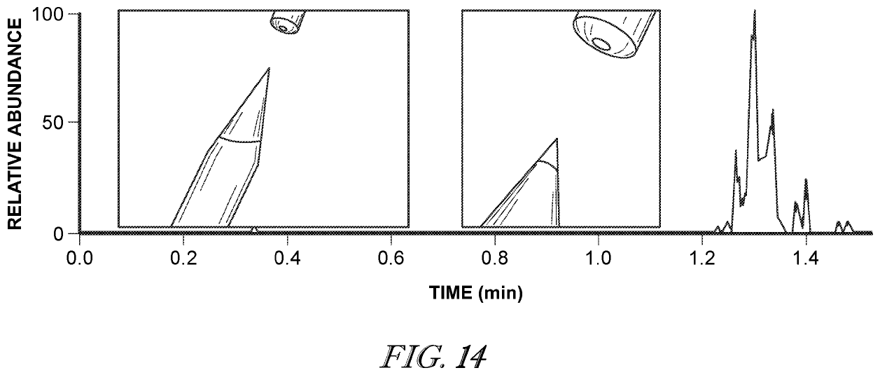

FASS stacking with online MS detection was achieved with organic dyes as proof-of-concept. Using a 3D printed cartridge 12 and base 14, methylene blue was stacked in 30 seconds. The dye was almost completely eluted and ionized within a 6 second window as shown in FIG. 14; without FASS stacking, the signal would have been spread out over more than 10 minutes. As a result, the detection limit improved more than 100× in this preliminary result.

FIG. 14 shows stacking and MS detection of methylene blue using on-cartridge FASS. The dye formed a visible band within 20 seconds and eluted in less than 2 minutes. The movement through the spray tip 26 provides an additional concentration factor as the channel narrows. Glass fiber paper was modified with silane coupling reagents to impart positive surface charge.

### Example 20: f-ICP Stacking

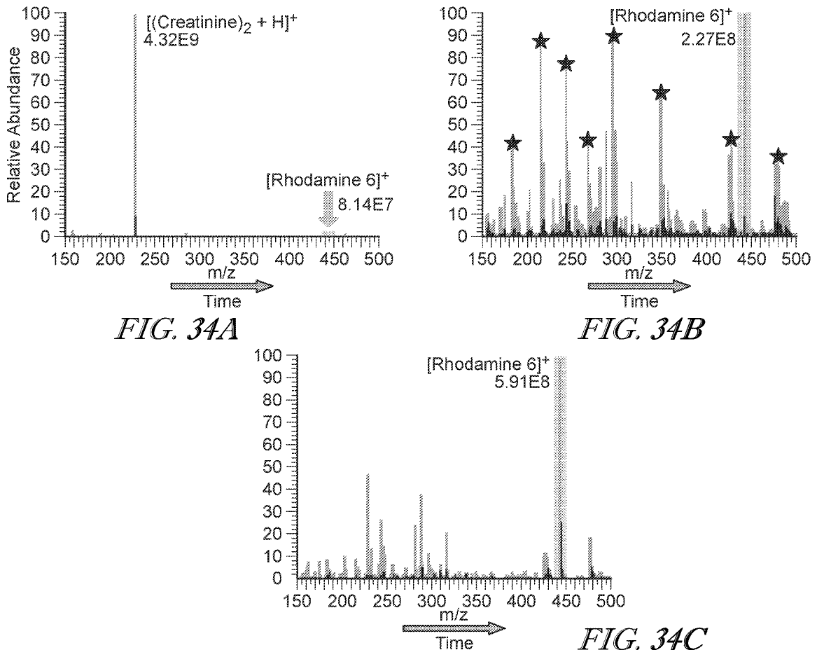

Stacking of fentanyl, hydrocodone, cocaine, and cocaethylene may be conducted using f-ICP. For this process, 60 μl of spiked urine was deposited on the first end 220 of the porous substrate 216 while making sure that the spray tip 226 remained dry. LODs in urine ranged from 7 to 80 ppt, an average improvement of 50-fold compared to unstacked paper spray. Calibration curves for fentanyl, cocaine, and cocaethylene using SIL-IS standards were linear from 50-5000 ppt, while hydrocodone exhibited good linearity from 100-5000 ppt, as shown in FIGS. 33A-33C. Urine volumes above 60 μL could be accommodated, but diminishing returns were observed due to increasing MS interference from endogenous urine cations that stacked and eluted with the target analytes. Creatinine, typically found in urine at mg/ml concentrations, was identified as the primary interfering substance, as shown in FIGS. 34A-34C.

Linear calibration curves were obtained for each analyte when using SIL-IS. To evaluate the effectiveness of non-SIL internal standards, cocaethylene, oxycodone, and 6-monoacetylmorphine was added to urine samples without their corresponding SIL-IS. Cocaine-D3 was used for cocaethylene and hydrocodone-D3 for oxycodone and 6-monoacetylmorphine. While these analyte-IS pairings yield satisfactory results in unstacked paper-spray MS, only cocaethylene with cocaine D3 could be accurately quantified when coupled with EK-stacking.

As an example, stacking of drugs in urine using f-ICP was performed. For unstacked paper spray, 10 μL urine samples were spotted on the paper and sprayed with a solvent of 90:10 ACN:H2O with 0.1% formic acid. Unstacked PFAS tap water samples were spotted on the paper (10 μL) and sprayed with a solvent of 98:2 MeOH:CCl3 with 0.1% ammonium hydroxide. f-ICP produced better results than FASS for identical sample volumes, likely because the lower BGE concentrations and higher organic solvent fraction in f-ICP are more favorable for ESI. FASS is also limited to low conductivity samples and is not feasible for urine analysis. However, for low conductivity samples like tap water, FASS could accommodate larger sample volumes than f-ICP and therefore had higher potential sensitivity improvements. Limits of detection (LODs) for stacked versus unstacked paper spray are shown in Table 3. For unstacked paper spray, 10 μL urine samples were spotted on the paper and sprayed with a solvent of 90:10 ACN:H₂O with 0.1% formic acid. Unstacked PFAS tap water samples were spotted on the paper (10 μL) and sprayed with a solvent of 98:2 MeOH:CCl3 with 0.1% ammonium hydroxide.

TABLE 3
Limits of detection (LODs) for stacked versus unstacked paper

| | Stacked | Unstacked | |
|---|---|---|---|
| Cocaine | 11 ppt | 730 | ppt |
| Fentanyl | 7 ppt | 330 | pp |
| Cocaethylene | 13 ppt | 850 | ppt |
| Hydrocodone | 80 ppt | 2200 | ppt |

### Example 21: Mathematical Modeling of the Stacking Processes

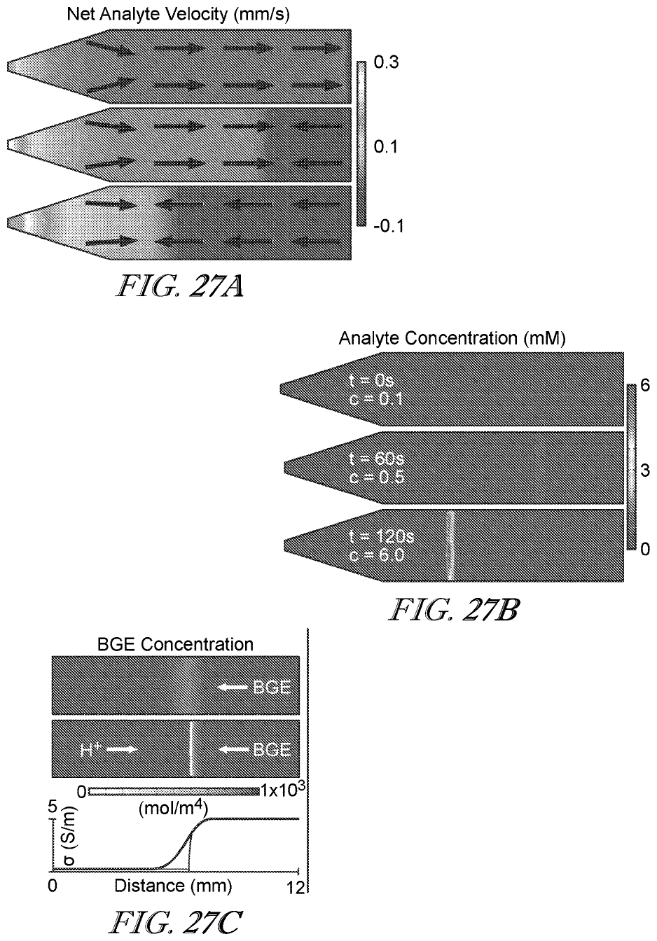

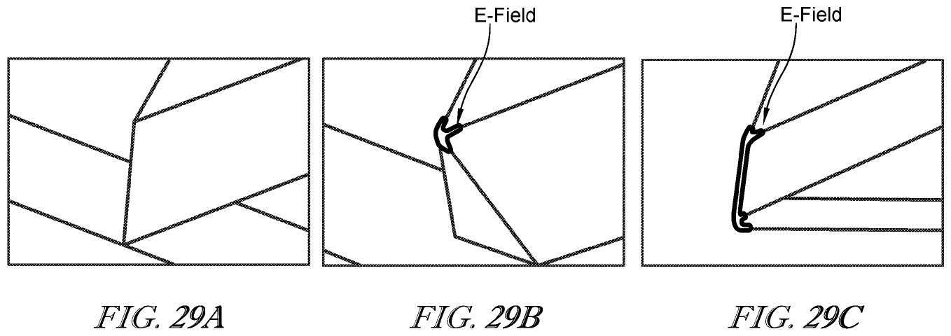

The stacking and band movement were modeled in COMSOL Multiphysics. Porous media models for cellulose and glass fiber papers were constructed, and then fluid flow and charged species transport was simulated. The mathematical model accounted for EOF, EP and diffusion of charged species, titration reactions and production of OH− and H+ ions at the electrodes, joule heating, and solvent evaporation. The dynamic evolution of the EOF in the fluid channel, which allows target analytes to initially electromigrate upstream by electrophoresis and then stack efficiently at the BGE interface as the EP velocity drops in the reduced electric field, is modeled in FIG. 27A. The model gave net analyte velocities consistent with experimental observations and reproduced the stacking behavior (see FIG. 27B). Methylene blue net velocity (FIG. 27A) and concentration (FIG. 27B) at three time points (0, 60, and 120 s) are shown. The modeling confirmed that stacking occurs at the interface 17 between the sample solution and high-conductivity BGE, where the net analyte velocity is zero. FIG. 29A shows the electric field distribution at a triangular spray tip. The electric field strength at the intersection of the porous substrate 16 and the substrate 28 was modeled to compare a flat cut triangular prism spray tip with the angled, half-pyramidal shaped spray tip 26 (see FIG. 2B) that was empirically found to improve ionization. The modeling indicates that a pyramidal spray tip 26 reduces the contribution of the substrate 26 to the electric field and shows that the angled spray tip 26 and lower position relative to the inlet 36 increases the electric field strength at the spray tip 26 by more than 30%. FIG. 29C shows the electric field strength at the junction of the angled tips 226, 229 (see FIG. 24). The electric field strength is greatest at the junction of the angled tips 226, 229.

The importance of BGE titration in forming a concentrated analyte band 42 was confirmed (see FIG. 27C). FIG. 27C shows that comparison of BGE concentration gradient within glass fiber paper under the conditions of continuous titration vs the absence of neutralization reactions. The conductivity gradient becomes sufficiently steep to carry out FASS with narrow bands only when an influx of H⁺ ions from the anode is present.

### Example 22: Complex Mixtures

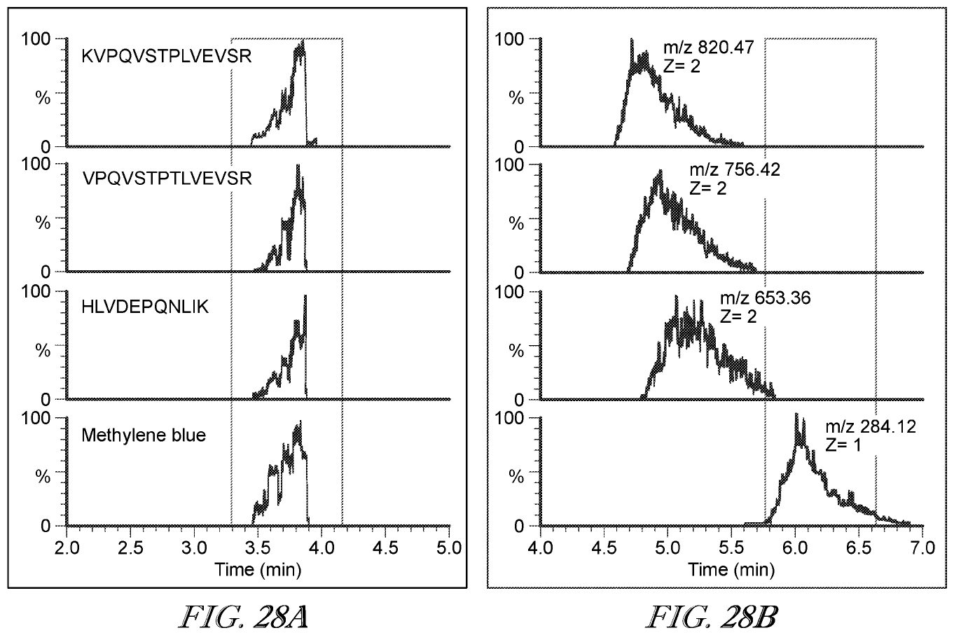

To test the impact of FASS separation on detection of analytes in complex mixtures, a bovine serum albumin (BSA) digest was spiked with a high concentration of methylene blue to simulate small-molecule interferents. The mixture was analyzed using two sets of parameters. In one, the experiment included a narrow and sharp electric field gradient along the paper to maximize stacking efficiency. As a result, the BSA peptides and the small molecule interferents (including methylene blue) co-eluted in a narrow window. FIG. 28A shows extracted ion electropherograms of three high intensity intact peptides eluting simultaneously in a narrow sample band. With the second set of parameters, the gradient was more gradual to improve the separation. As a result, the BSA peptides were crudely separated over a larger time window and were completely separated from the higher-mobility small molecule interferents (see FIG. 28B). FIG. 28B shows electropherograms depicting analysis of the same peptide solution with FASS separation.

Crude separation of the peptides reduced spectral interference and also increased the number of peptides identified by 41% (from an average of 22 peptides using optimal stacking parameters compared to 31 peptides using separation parameters). Under experimental conditions conducive to separation, the peak intensities of the peptides were on average lower than those in non-separated samples due to less efficient stacking. However, the reduced spectral crowding and ion suppression resulted in more peptide identifications.

1. An analyte stacking device for concentrating an analyte of interest for particle spectrometry, the analyte stacking device comprising:
a porous substrate having a first end and a second end opposite the first end, the second end defining a spray tip;
a sample solution comprising the analyte of interest;
a background electrolyte (BGE) solution fluidly coupled to one of the first or second end of the porous substrate;
a first voltage source configured to apply a first voltage across the porous substrate to establish a first electric field between the first and second ends of the porous substrate;
wherein, with the sample solution applied to the porous substrate and in response to the first electric field across the porous substrate, the BGE solution flows through the porous substrate with a first flow velocity in a first direction from the one of the first or second end of the porous substrate toward the other of the first or second end of the porous substrate, the analyte of interest flows through the porous substrate toward the BGE solution with a second flow velocity in a second direction opposite the first direction and, upon meeting of the analyte of interest with the BGE solution, an interface is formed on the porous substrate along which the analyte of interest becomes concentrated to form a sample band of the analyte of interest; and
means for controlling a flow rate of the BGE solution to the one of the first or second end of the porous substrate so as to control a magnitude of the first flow velocity relative to a magnitude of the second flow velocity in a manner which moves the sample band of the analyte of interest toward the spray tip.

2. The stacking device of claim 1, wherein the spray tip forms a Taylor cone.

3. The stacking device of claim 1, further comprising a capillary extending from the spray tip, and wherein the analyte of interest passes from the spray tip through the capillary.

4. The stacking device of claim 1, further comprising a reservoir configured to receive the BGE solution such that the BGE solution flows from the reservoir to the one of the first or second end of the porous substrate.

5. The stacking device of claim 4, wherein the means for controlling the flow rate of the BGE solution to the one of the first or second end of the porous substrate comprises a temperature control unit configured to cool the reservoir and the BGE solution received therein.

6. The stacking device of claim 1, further comprising a voltage source connection substrate coupled to one of the first or second end of the porous substrate opposite the BGE solution, and wherein the voltage source connection substrate is coupled to the second end of the porous substrate and includes a first end and a second end opposite the first end, the second end defining a sharp tip, and wherein the sharp tip of the voltage source connection substrate contacts the spray tip of the porous substrate.

7. (canceled)

8. The stacking device of claim 6, wherein an angle of about 30 degrees is formed between the porous substrate and the voltage source connection substrate.

9. The stacking device of claim 1, wherein the means for controlling the flow rate of the BGE solution to the one of the first or second end of the porous substrate comprises a flow substrate configured to direct the BGE solution to the one of the first or second end of the porous substrate.

10. The stacking device of claim 9, wherein the flow substrate is a low flow rate filter paper, and wherein a width of the flow substrate is adjusted to control the flow rate of the BGE solution.

11. (canceled)

12. The stacking device of claim 1, wherein the means for controlling the flow rate of the BGE solution to the one of the first or second end of the porous substrate comprises a pump configured to direct the BGE solution to the one of the first or second end of the porous substrate.

13. A charged particle separation system, comprising:
a charged particle separation instrument having a charged particle inlet, the charged particle separation instrument configured to separate charged particles as a function of at least one molecular characteristic;
an ion source including the analyte stacking device of claim 1, wherein the spray tip is spaced apart from the charged particle inlet of the charged particle separation instrument to define a gap, and wherein the first voltage source is configured to establish a first voltage at the second end of the porous substrate; and
a second voltage source configured to establish a second voltage at the charged particle inlet of the charged particle separation instrument so as to establish a second electric field between the spray tip of the analyte stacking device and the charged particle inlet of the charged particle separation instrument, the second electric field causing the spray tip to spray charged particles of the analyte of interest toward and into the inlet of the charged particle separation instrument.

14. An analyte stacking device for concentrating an analyte of interest for particle spectrometry, the analyte stacking device comprising:
a porous substrate having a first end and a second end opposite the first end, the second end defining a spray tip;
a sample solution comprising the analyte of interest;
a background electrolyte (BGE) solution fluidly coupled to one of the first or second end of the porous substrate;
a first voltage source configured to apply a first voltage across the porous substrate to establish a first electric field between the first and second ends of the porous substrate;
wherein, with the sample solution applied to the porous substrate and in response to the first electric field across the porous substrate, the BGE solution flows through the porous substrate with a first flow velocity in a first direction from the one of the first or second end of the porous substrate toward the other of the first or second end of the porous substrate, the analyte of interest flows through the porous substrate toward the BGE solution with a second flow velocity in a second direction opposite the first direction and, upon meeting of the analyte of interest with the BGE solution, an interface is formed on the porous substrate along which the analyte of interest becomes concentrated to form a sample band of the analyte of interest; and
a flow substrate fluidly coupled with the first or second end of the porous substrate and configured to control a flow rate of the BGE solution to the one of the first or second end of the porous substrate so as to control a magnitude of the first flow velocity relative to a magnitude of the second flow velocity in a manner which moves the sample band of the analyte of interest toward the spray tip.

15. (canceled)

16. (canceled)

17. The stacking device of claim 14, further comprising a reservoir configured to receive the BGE solution such that the BGE solution flows from the reservoir, to the flow substrate, and to the one of the first or second end of the porous substrate.

18. The stacking device of claim 14, further comprising a voltage source connection substrate coupled to one of the first or second end of the porous substrate opposite the flow substrate.

19. (canceled)

20. An analyte stacking device for concentrating an analyte of interest for particle spectrometry, the analyte stacking device comprising:
a porous substrate having a first end and a second end opposite the first end, the second end defining a spray tip;
an angled substrate having a first end and a second end opposite the first end, the second end defining a sharp tip in contact with the spray tip so that the porous substrate and the angled substrate cooperate to form a fluid channel;
a sample solution comprising the analyte of interest;
a background electrolyte (BGE) solution fluidly coupled to the first end of the porous substrate;
a first voltage source configured to apply a first voltage across the fluid channel to establish a first electric field between the first end of the porous substrate and the first end of the angled substrate;
wherein, with the sample solution applied to the porous substrate and in response to the first electric field across the fluid channel, the BGE solution flows through the porous substrate with a first flow velocity in a first direction from the first end of the porous substrate toward the second end of the porous substrate, the analyte of interest flows through the porous substrate with the BGE solution in the first direction and onto the angled substrate and, in response to the first electric field and neutralization of the BGE solution, an ion-depletion zone is formed on the angled substrate, and upon meeting of the analyte of interest with the ion-depletion zone, the analyte of interest becomes concentrated to form a sample band of the analyte of interest, and the sample band of the analyte of interest is directed toward the sharp tip of the angled substrate and onto the spray tip of the porous substrate via a propagating ion-depletion zone.

21. (canceled)

22. (canceled)

23. The stacking device of claim 20, further comprising a reservoir configured to receive the BGE solution such that the BGE solution flows from the reservoir to the first end of the porous substrate.

24. The stacking device of claim 23, further comprising a flow substrate fluidly coupled with the reservoir and the first end of the porous substrate to direct the BGE solution to the first end of the porous substrate, and wherein an angle of about 30 degrees is formed between the porous substrate and the angled substrate.

25. (canceled)

26. The stacking device of claim 20, wherein the analyte stacking device includes means for controlling a flow rate of the BGE solution to the second end of the porous substrate so as to control a magnitude of the first flow velocity in a manner which moves the sample band of the analyte of interest toward the spray tip.

27. The stacking device of claim 26, wherein the means for controlling the flow rate of the BGE solution to the second end of the porous substrate comprises a temperature control unit configured to cool the reservoir and the BGE solution received therein.

28. The stacking device of claim 26, wherein the means for controlling the flow rate of the BGE solution to the second end of the porous substrate comprises a flow substrate configured to direct the BGE solution onto the first end of the porous substrate, and wherein the flow substrate is a low flow rate filter paper, and wherein a width of the flow substrate is adjusted to control the flow rate of the BGE solution.

29-32. (canceled)
